(19) United States
(12) Patent Application Publication
(10) Pub. No.: US 2026/0029748 A1
(43) Pub. Date: Jan. 29, 2026

(54) IMAGE FORMING APPARATUS AND REMOVABLE BODY

(71) Applicant: FUJIFILM Business Innovation Corp., Tokyo (JP)

(72) Inventors: Taiyou UEHARA, Kanagawa (JP); Katsumi YAMADA, Kanagawa (JP); Hiroaki OKUMA, Kanagawa (JP); Kazuya UMEKUBO, Kanagawa (JP); Atsushi FUNADA, Kanagawa (JP)

(73) Assignee: FUJIFILM Business Innovation Corp., Tokyo (JP)

(21) Appl. No.: 19/056,297

(22) Filed: Feb. 18, 2025

(30) Foreign Application Priority Data
Jul. 25, 2024 (JP) 2024-119269
Jul. 25, 2024 (JP) 2024-119270
Jul. 25, 2024 (JP) 2024-119271

(51) Int. Cl. G03G 21/20; G03G 15/08

(52) U.S. Cl. CPC G03G 21/206; G03G 15/0865

(57) ABSTRACT

An image forming apparatus includes an image carrier, at least one developing device that applies a developer to the image carrier, and a transport device that transports a developer discharged from the developing device, the transport device having at least one gas opening that is an opening to be used to discharge a gas that has flowed from the developing device to the transport device.

### CROSS-REFERENCE TO RELATED APPLICATIONS

This application is based on and claims priority under 35 USC 119 from Japanese Patent Application No. 2024-119269 filed Jul. 25, 2024, No. 2024-119270 filed Jul. 25, 2024, and No. 2024-119271 filed Jul. 25, 2024.

### BACKGROUND

### (i) Technical Field

The present disclosure relates to an image forming apparatus and a removable body.

### (ii) Related Art

Japanese Unexamined Patent Application Publication No. 2006-84487 discloses an image forming apparatus that includes a toner transport section that connects a toner supply unit and a developing device to each other and in which a pressure-relief filter is provided in the toner transport section.

Japanese Unexamined Patent Application Publication No. 2006-235474 discloses a configuration in which a paddle-shaped structure is provided, so as to correspond to a communication path, at a downstream position of a first stirring and transport screw that is located closer to a developing sleeve.

### SUMMARY

In a developing device that applies a developer to an image carrier that carries an image, the internal pressure of the developing device may sometimes increase during an operation of the developing device.

In the case where an opening for relieving the internal pressure of the developing device is provided in the developing device, the distance between the opening and the interior of the developing device, where the internal pressure increases, becomes smaller compared with the case where the opening is provided at a location other than the developing device. In this case, the developer inside the developing device is more likely to reach the opening. A filter is often provided at such an opening, and if a developer easily reaches the opening, it tends to lead to a shortened service life of the filter.

Aspects of non-limiting embodiments of the present disclosure relate to enabling the internal pressure of a developing device to be relieved at a location other than the developing device.

In addition, an image forming apparatus may sometimes include a developing device, which applies a developer to an image carrier, and a supply device that has a developer flow path through which a developer passes, the supply device being configured to supply the developer to the developing device.

Here, a case is assumed where an opening for discharging a gas inside the supply device to the outside is provided directly above the developer flow path of the supply device. In this case, the developer floating within the developer flow path is more likely to reach the opening. In this case, if a filter is provided at the opening, a large amount of developer may be supplied to the filter, which may result in a shorter service life of the filter.

Other aspects of non-limiting embodiments of the present disclosure relate to reducing the amount of a developer that flows toward an opening used for discharging a gas compared with the case where the opening for discharging a gas is provided directly above a developer flow path.

In addition, in an image forming apparatus, a device that handles powder such as a developer may be equipped with a filter. In general, the service file of the filter is shorter than the service file of a body of the device to which the filter is attached. In this case, when the filter reaches the end of its service life, the old filter is replaced with a new filter. During a filter replacement process, tasks such as removal of the old filter and installation of the new filter, which are specific to filter replacement, are performed by an operator.

Other aspects of non-limiting embodiments of the present disclosure relate to achieving simplification of a task involved in filter replacement, compared to the case where a filter is installed in a device that is not designed for frequent attachment and detachment.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including an image carrier, at least one developing device that applies a developer to the image carrier, and a transport device that transports a developer discharged from the developing device, the transport device having at least one gas opening that is an opening to be used to discharge a gas that has flowed from the developing device to the transport device.

### BRIEF DESCRIPTION OF THE DRAWINGS

An exemplary embodiment of the present disclosure will be described in detail based on the following figures, wherein:

FIG. 1 is a diagram illustrating an image forming apparatus;

FIG. 2 is a diagram illustrating a developing device as viewed from above;

FIG. 3 is a cross-sectional view of the developing device taken along line III-III of FIG. 2;

FIG. 4 is a cross-sectional view of the developing device taken along line IV-IV of FIG. 2;

FIG. 5 is a cross-sectional view of the developing device taken along line V-V of FIG. 2;

FIG. 6 is a sectional view of the developing device taken along line VI-VI of FIG. 5;

FIG. 7 is a perspective view of a supply device as viewed from the rear side of the image forming apparatus;

FIG. 8 is a diagram illustrating a developer accumulation unit;

FIGS. 9A and 9B are diagrams each illustrating a filling portion and a gas flow path;

FIG. 10 is a perspective view of the developer accumulation unit as viewed from above;

FIG. 11 is an enlarged view of an end portion of the developer accumulation unit;

FIG. 12 is a diagram illustrating a state where an upper member is mounted on a lower container;

FIG. 13 is a sectional view of the supply device taken along line XIII-XIII of FIG. 7;

FIG. 14 is a cross-sectional view of the supply device taken in a plane perpendicular to the longitudinal direction of a developer container;

FIG. 15 is a diagram illustrating a flow of a gas when the supply device is viewed from above;

FIG. 16 is a diagram illustrating another configuration example of the supply device and another configuration example of the developer container;

FIG. 17 is a cross-sectional view of the supply device and the developer container taken along line XVII-XVII of FIG. 16;

FIG. 18 is a diagram illustrating another configuration example of the developer container;

FIG. 19 is a diagram illustrating another configuration example of a body-side flow path;

FIG. 20 is a diagram illustrating another configuration example of the supply device and another configuration example of the developer container;

FIG. 21 is a diagram illustrating another configuration example of the developer container;

FIG. 22 is a diagram illustrating another configuration example of the supply device and another configuration example of the developer container;

FIG. 23 is a diagram illustrating the supply device and the developing device as viewed from above;

FIG. 24 is a perspective view of the supply device and the developing device as viewed from below;

FIG. 25 is a cross-sectional view of the supply device taken along line XXV-XXV of FIG. 23;

FIG. 26 is a diagram illustrating an inlet as seen from the direction of arrow XXVI in FIG. 25;

FIG. 27 is a cross-sectional view of the supply device taken along line XXVII-XXVII of FIG. 23;

FIG. 28 is a diagram illustrating a transport device and a waste container; and

FIG. 29 is a diagram illustrating an internal configuration of a lateral-direction transport unit.

### DETAILED DESCRIPTION

An exemplary embodiment of the present disclosure will be described below with reference to the accompanying drawings.

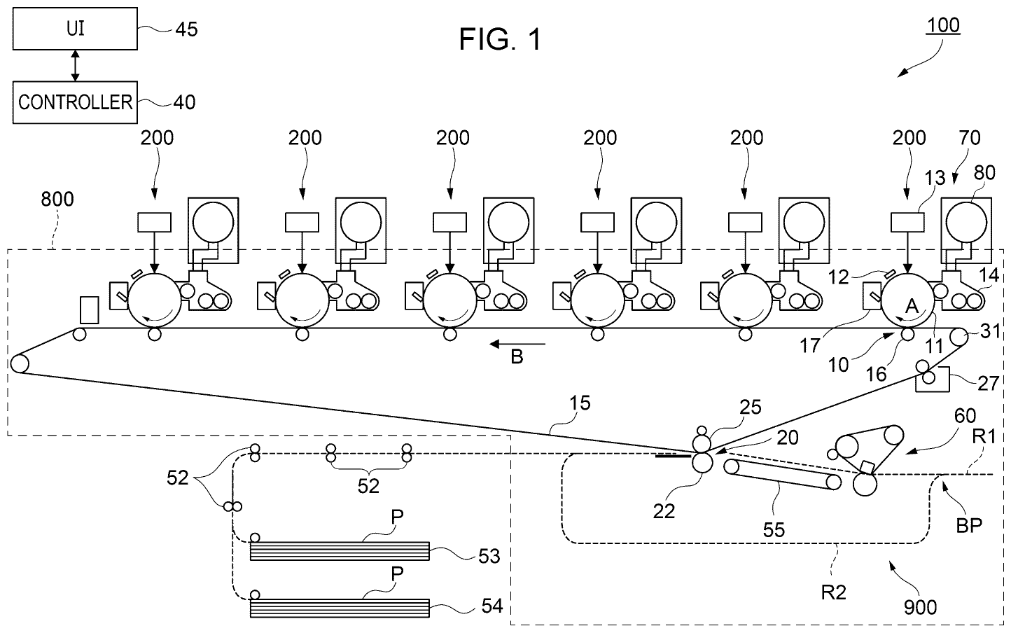

FIG. 1 is a diagram illustrating an image forming apparatus 100 according to the present exemplary embodiment. FIG. 1 illustrates the image forming apparatus 100 as viewed from the front side of the image forming apparatus 100.

The image forming apparatus 100 is an image forming apparatus that is called a tandem-type image forming apparatus employing an intermediate transfer system.

The image forming apparatus 100 includes multiple image forming sections 200. Each of the image forming sections 200 forms an image to be transferred onto a sheet P, which is an example of a recording medium.

Each of the image forming sections 200 includes a photoconductor drum 11, which is an example of an image carrier.

Each of the image forming sections 200 forms a toner image, which is an image to be transferred onto the sheet P, on the photoconductor drum 11 by using a developer containing a toner. In other words, each of the image forming sections 200 forms a toner image onto the photoconductor drum 11 by using a powder developer.

In the present exemplary embodiment, each developer includes a dry carrier and a dry toner. Each of the image forming sections 200 forms a toner image onto the photoconductor drum 11 by using the carrier and the toner.

The six image forming sections 200 use their respective developers, which differ from each other, so as to form toner images onto their respective photoconductor drums 11.

Four of the six image forming sections 200 each form a toner image by using a basic-color developer. More specifically, the four image forming sections 200 use yellow developer, magenta developer, cyan developer, and black developer, respectively, so as to form toner images.

The other two image forming sections 200 form toner images by using developers other than basic-color developers.

The other two image forming sections 200 each form a toner image by using, for example, clear developer, white developer, gold developer, or silver developer. Alternatively, the other two image forming sections 200 each form a toner image by using, for example, pink developer, green developer, or orange developer.

Other examples of the developers that are not basic-color developers include a developer containing a magnetic toner, a developer containing an electrically conductive toner, and a developer containing a toner that emits light by being irradiated with light, such as ultraviolet rays or infrared rays.

Note that, in the present exemplary embodiment, a so-called two-component developer in which a carrier and a toner are mixed together is used as each developer. Alternatively, a so-called mono-component developer that contains only a toner may be used as each developer.

The image forming apparatus 100 further includes an intermediate transfer belt 15. The image forming apparatus 100 further includes first transfer sections 10. The toner images formed by the image forming sections 200 are transferred at their respective first transfer sections 10 onto the intermediate transfer belt 15.

The image forming apparatus 100 further includes a second transfer section 20. The toner images transferred to the intermediate transfer belt 15 are transferred onto the sheet P at the second transfer section 20.

The image forming apparatus 100 further includes a fixing device 60 that fixes the toner images, which have been transferred to the sheet P, onto the sheet P.

The image forming apparatus 100 further includes a controller 40 that includes a CPU that executes a program. The controller 40 controls each unit of the image forming apparatus 100.

The image forming apparatus 100 further includes a user interface (UI) 45. The UI 45 includes, for example, a display panel. The UI 45 receives an instruction from a user. The UI 45 also displays information to the user.

Each of the image forming sections 200 includes a developing device 14. Each of the image forming sections 200 further includes a supply device 70.

The developing device 14 applies the developer to the photoconductor drum 11. The supply device 70 supplies the developer to the developing device 14.

Once the developing device 14 has applied the developer to the photoconductor drum 11, an electrostatic latent image on the photoconductor drum 11 is developed into a visible image with the toner. The developing device 14 performs development on the photoconductor drum 11, which is an image carrier. As a result, an image is formed of the toner onto the photoconductor drum 11.

The supply device 70 supplies a new developer to the developing device 14.

Developer containers 80 are installed in the image forming apparatus 100. The developer from each of the developer containers 80 is transported by the corresponding supply device 70 toward the corresponding developing device 14. As a result, the developer is supplied to the developing device 14.

As described above, each developer includes a carrier and a toner. The supply device 70 supplies, as the developer, the carrier and the toner to the developing device 14. Note that, in the present exemplary embodiment, the carrier and the toner have a positive charge polarity and a negative charge polarity, respectively.

In each of the image forming sections 200, the photoconductor drum 11, which is an example of an image carrier, rotates in the direction of arrow A.

Each of the image forming sections 200 further includes a charger 12. Each of the image forming sections 200 further includes an exposure device 13.

The charger 12 charges the photoconductor drum 11 with electricity. The exposure device 13 forms an electrostatic latent image on the photoconductor drum 11.

The exposure device 13 includes a light source such as an LED. The exposure device 13 forms an electrostatic latent image on the photoconductor drum 11 by radiating light onto the photoconductor drum 11.

Each of the image forming sections 200 further includes a first transfer roller 16. The first transfer rollers 16 are provided at their respective first transfer sections 10. The first transfer roller 16 is used to transfer a toner image from the photoconductor drum 11 to the intermediate transfer belt 15.

Each of the image forming sections 200 further includes a drum cleaner 17 that removes the developer remaining on the corresponding photoconductor drum 11.

The intermediate transfer belt 15 is caused by a driving roller 31 to move circularly at a predetermined speed in the direction of arrow B illustrated in FIG. 1. The driving roller 31 is driven by a motor (not illustrated) so as to rotate in the counterclockwise direction in FIG. 1.

Each of the first transfer sections 10 includes one of the first transfer rollers 16, and each of the first transfer rollers 16 is disposed in such a manner as to face the corresponding photoconductor drum 11 with the intermediate transfer belt 15 interposed therebetween. The toner images on the photoconductor drums 11 are transferred onto the intermediate transfer belt 15 at their respective first transfer sections 10. As a result, the toner images are formed on the intermediate transfer belt 15.

The second transfer section 20, which is an example of a transfer section, includes a second transfer roller 22 that is disposed in such a manner as to face the outer surface of the intermediate transfer belt 15. The second transfer section 20 further includes a backup roller 25 that is disposed in such a manner as to face the inner surface of the intermediate transfer belt 15.

In the second transfer section 20, the toner images formed on the intermediate transfer belt 15 are transferred onto the sheet P that has been transported to the second transfer section 20.

In addition, a reversing mechanism 900 that reverses the sheet P is provided.

In a state where the toner images have been transferred to one surface of the sheet P at the second transfer section 20, the reversing mechanism 900 flips the front and back of the sheet P. Then, the sheet P that has been flipped over is supplied to the second transfer section 20 again by the reversing mechanism 900.

As a result, formation of toner images is performed on both surfaces of the sheet P.

The reversing mechanism 900 feeds the sheet P that has passed through the fixing device 60 into a branch path R2 that branches off from a sheet transport path R1.

After the sheet P has passed through a branching portion BP, the reversing mechanism 900 transports the sheet P in a reverse direction. In addition, the reversing mechanism 900 feeds the sheet P into the branch path R2.

The branch path R2 merges with the sheet transport path R1 on the upstream side of the second transfer section 20. As a result, the sheet P that has fed to the branch path R2 is supplied to the second transfer section 20 again. The sheet P is supplied to the second transfer section 20 again after being flipped over.

In this case, toner images are formed on one surface of the sheet P as well as on the other surface of the sheet P. Therefore, toner images are formed on both the surfaces of the sheet P.

A processing flow of the image forming apparatus 100 will now be described.

The image forming apparatus 100 receives, for example, image data that is output by an image reading device or a computer (not illustrated). Then, the image forming apparatus 100 performs image processing on this image data. As a result, image data components each of which corresponds to one of the multiple image forming sections 200 are generated.

More specifically, image data components each of which corresponds to one of four basic colors, which are yellow, magenta, cyan, and black, are generated. In addition, image data components that correspond to colors that are not the basic colors are generated.

The generated image data components are each output to a corresponding one of the exposure devices 13 of the image forming sections 200.

The exposure device 13 radiates light onto the photoconductor drum 11 in accordance with the image data input thereto, the light being emitted from the light source.

Before the exposure device 13 radiates the light, the surface of the photoconductor drum 11 is charged by the charger 12. After this charging, the exposure device 13 radiates the light onto the surface. As a result, an electrostatic latent image is formed on the surface of the photoconductor drum 11.

Next, development is performed by the developing device 14, and the toner contained in the developer is deposited onto the photoconductor drum 11. As a result, a toner image is formed on the photoconductor drum 11. This toner image is transferred onto the intermediate transfer belt 15 at the first transfer section 10.

After the toner images have been transferred to the intermediate transfer belt 15, these toner images are moved toward the second transfer section 20 along with movement of the intermediate transfer belt 15.

In this case, the sheet P is transported from a first sheet-accommodating unit 53 or a second sheet-accommodating unit 54 toward the second transfer section 20 by transport rollers 52 and the like. Then, the toner images on the intermediate transfer belt 15 are collectively and electrostatically transferred onto the sheet P at the second transfer section 20.

After that, the sheet P to which the toner images have been transferred is separated from the intermediate transfer belt 15 and transported toward a transport belt 55. The transport belt 55 transports the sheet P toward the fixing device 60.

The sheet P transported to the fixing device 60 is heated and pressurized by the fixing device 60. As a result, the toner images on the sheet P are fixed to the sheet P. Then, the sheet P is discharged from the image forming apparatus 100.

Note that, when toner images are formed onto the two surfaces of the sheet P, the sheet P that has passed through the fixing device 60 is transported to the branch path R2. In this case, toner images have been formed on one of the surfaces of the sheet P. In this state, the sheet P passes through the second transfer section 20 again.

Toner images are transferred onto the other surface of the sheet P at the second transfer section 20. After that, the sheet P passes through the fixing device 60 again such that the toner images that have been transferred to the other surface are fixed to the sheet P.

The developing devices 14 will now be described.

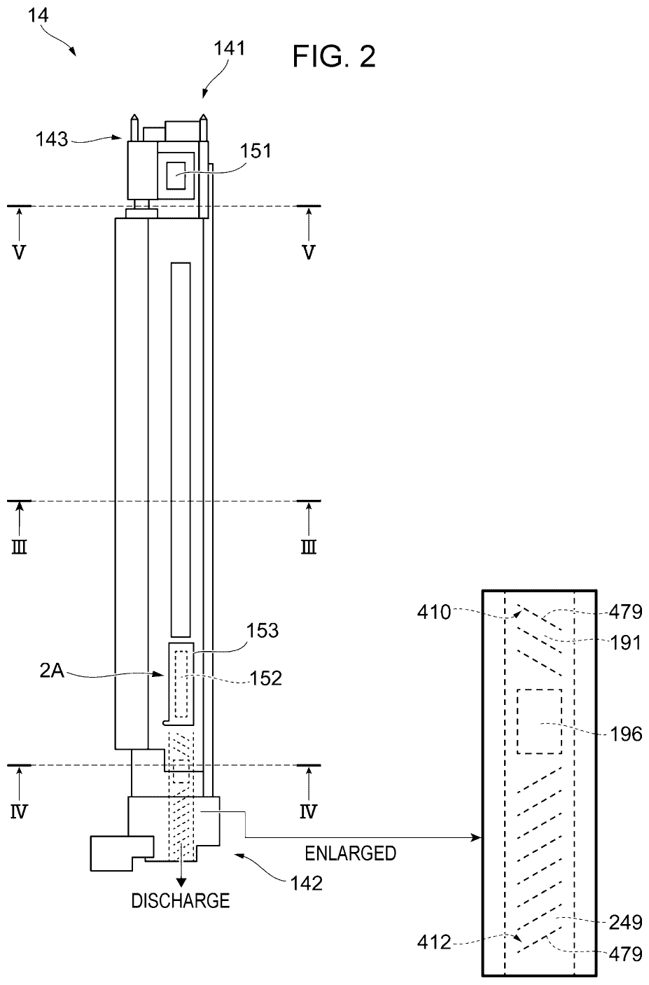

FIG. 2 is a diagram illustrating one of the developing devices 14 as viewed from above.

When the developing devices 14 are installed in the image forming apparatus 100, they are arranged along the depth direction of the image forming apparatus 100. The developing device 14 includes a first end portion 141 and a second end portion 142 that are located at different positions in the longitudinal direction of the developing device 14.

When the developing device 14 is installed in the image forming apparatus 100, the first end portion 141 is located on the rear side of the image forming apparatus 100, and the second end portion 142 is located on the front side of the image forming apparatus 100.

The first end portion 141 of the developing device 14 is provided with a driving-force receiver 143 that receives a driving force. A driving force from a driving source (not illustrated), such as a motor, that is provided at a body 100H of the image forming apparatus 100 is transmitted to the driving-force receiver 143

The driving-force receiver 143 is linked to a transport member and the like (described later) that are provided inside the developing device 14. The transport member and the like rotates in response to the driving force from the driving source being transmitted to the driving-force receiver 143.

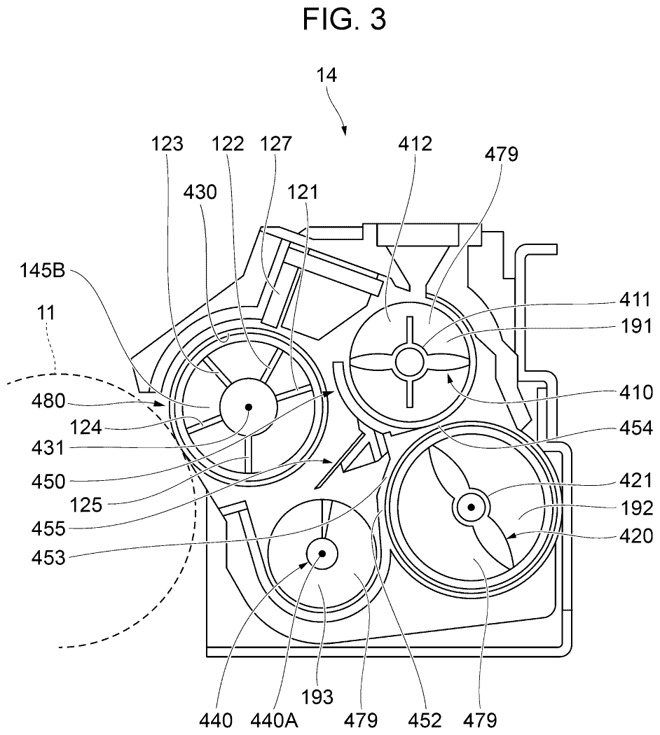

FIG. 3 is a cross-sectional view of the developing device 14 taken along line III-III of FIG. 2. FIG. 3 illustrates a cross section at a central portion of the developing device 14 in the longitudinal direction.

The developing device 14 has a first-direction movement path 191 through which the developer passes when it moves in a first direction.

The developing device 14 also has an opposite-direction movement path 192 through which the developer passes when it moves toward the side opposite to the first direction. The opposite-direction movement path 192 is provided below the first-direction movement path 191.

In the first-direction movement path 191, the developer moves in the direction perpendicular to the plane of FIG. 3 and in the direction toward the back side of the plane of FIG. 3. In the opposite-direction movement path 192, the developer moves in the direction perpendicular to the plane of FIG. 3 and in the direction toward the front side of the plane of FIG. 3.

The first-direction movement path 191 is provided with a first-direction transport member 410 that transports the developer. The first-direction transport member 410 includes a helical projecting portion 479 that is provided around a rotary shaft 411.

The first-direction transport member 410 rotates about the rotary shaft 411 that extends along the first-direction movement path 191. The rotation of the first-direction transport member 410 moves the developer in the direction toward the back side of the plane of FIG. 3.

The opposite-direction movement path 192 is provided with an opposite-direction transport member 420 that transports the developer. The opposite-direction transport member 420 is positioned below the first-direction transport member 410. The opposite-direction transport member 420 includes another helical projecting portion 479.

The opposite-direction transport member 420 rotates about a rotary shaft 421 that extends along the opposite-direction movement path 192. Consequently, the developer transported by the opposite-direction transport member 420 moves in the direction toward the front side of the plane of FIG. 3.

The developer is transported by the opposite-direction transport member 420 in a direction that is opposite to the above-mentioned first direction.

In addition, a rotary body 430 is disposed on the left side of the first-direction transport member 410. The rotary body 430 is used to supply the developer to the photoconductor drum 11, which is an example of an image carrier.

In addition, the developing device 14 has an opposing opening 480. The opposing opening 480 is formed at a position where the opposing opening 480 faces the photoconductor drum 11.

The rotary body 430 is positioned at the opposing opening 480. In the present exemplary embodiment, the rotary body 430 is partially exposed through the opposing opening 480.

The rotary body 430 supplies the developer that is supplied thereto from the first-direction transport member 410 to the photoconductor drum 11. The rotary body 430 receives the developer supplied from the first-direction transport member 410 and supplies this developer to the photoconductor drum 11.

The rotary body 430 is formed of a cylindrical body. The rotary body 430 is made of, for example, a metal such as SUS.

The rotary body 430 rotates in the counterclockwise direction in FIG. 3 about an axial center 431 as its center of rotation. The rotary body 430 moves the developer that has been supplied from the first-direction transport member 410 and attached to the outer peripheral surface thereof to the photoconductor drum 11.

As a result, the developer is supplied to the photoconductor drum 11, and the toner contained in the developer is applied to the surface of the photoconductor drum 11.

A first movement-restricting portion 450 is provided between the rotary body 430 and the first-direction transport member 410. The first movement-restricting portion 450 restricts movement of part of the developer moving from the first-direction transport member 410 toward the rotary body 430.

In the present exemplary embodiment, part of the developer present on the first-direction movement path 191 flows over the first movement-restricting portion 450. In the present exemplary embodiment, the developer that has flowed over the first movement-restricting portion 450 is supplied to the rotary body 430.

A lower transport member 440 is provided below the rotary body 430.

The lower transport member 440 is a rotary member that rotates about an axial center 440A extending along the above-mentioned first direction. The lower transport member 440 includes another helical projecting portion 479.

The lower transport member 440 is disposed so as to be closer to the photoconductor drum 11 than the opposite-direction transport member 420 is.

The lower transport member 440 transports the developer separated from the rotary body 430 in the direction perpendicular to the plane of FIG. 3 and in the direction toward the back side of the plane of FIG. 3.

The lower transport member 440 transports the developer separated from the rotary body 430 in the above-mentioned first direction. As a result, the developer is supplied to the side on which first end portion of the opposite-direction transport member 420 is located (details of this matter will be described later).

A second movement-restricting portion 452 is provided between the lower transport member 440 and opposite-direction transport member 420. The second movement-restricting portion 452 restricts movement of the developer from the opposite-direction transport member 420 toward the lower transport member 440.

A third movement-restricting portion 453 is provided between the rotary body 430 and the opposite-direction transport member 420. The third movement-restricting portion 453 restricts movement of the developer from the opposite-direction transport member 420 toward the rotary body 430.

A fourth movement-restricting portion 454 is provided between the first-direction transport member 410 and the opposite-direction transport member 420.

The fourth movement-restricting portion 454 restricts movement of the developer from the first-direction transport member 410 toward the opposite-direction transport member 420. The fourth movement-restricting portion 454 also restricts movement of the developer from the opposite-direction transport member 420 toward the first-direction transport member 410.

A fifth movement-restricting portion 455 is provided between the rotary body 430 and the lower transport member 440. The fifth movement-restricting portion 455 restricts movement of the developer from the lower transport member 440 toward the rotary body 430.

A magnet roller 145B is provided inside the rotary body 430.

The magnet roller 145B includes five magnetic poles 121 to 125 that are arranged in the circumferential direction of the magnet roller 145B.

The magnetic pole 121 is a pickup pole and attracts the developer supplied from the first-direction movement path 191. As a result, the developer is applied to a surface of the rotary body 430.

The magnetic poles 122 to 124 each serve as a transport pole. The magnetic poles 122 to 124 move the developer on the surface of the rotary body 430 toward the downstream side in the direction of rotation of the rotary body 430.

An opposing restricting portion 127 is provided at a position that is further downstream than the magnetic pole 122 is and further upstream than the magnetic pole 123 is in the direction of rotation of the rotary body 430. The opposing restricting portion 127 is disposed at a position where the opposing restricting portion 127 faces the outer peripheral surface of the rotary body 430.

The opposing restricting portion 127 is disposed with a gap formed between the opposing restricting portion 127 and the rotary body 430. The opposing restricting portion 127 restricts movement of part of the developer attached to the surface of the rotary body 430. As a result, the thickness of the developer attached to the surface of the rotary body 430 becomes a predetermined thickness.

The developer on the surface of the rotary body 430 moves toward the downstream side in the direction of rotation of the rotary body 430. After that, this developer moves to the surface of the photoconductor drum 11, and the toner contained in the developer is deposited onto the photoconductor drum 11.

As a result, development is performed, and a toner image is formed on the surface of the photoconductor drum 11.

This toner image is in a state of being temporarily held by the photoconductor drum 11. The toner image is then moved to the first transfer section 10 (see FIG. 1) by the photoconductor drum 11, which rotates. Subsequently, the toner image is transferred onto the intermediate transfer belt 15.

The magnetic pole 125 (see FIG. 3) serves as a pick-off pole. The magnetic pole 125 forms a repulsive magnetic field and separates the developer attached to the surface of the rotary body 430 from the rotary body 430.

The magnetic pole 125 separates the developer that has not been transferred to the photoconductor drum 11 from the rotary body 430.

The developer separated from the rotary body 430 moves downward and reaches a lower movement path 193.

The developer that has reached the lower movement path 193 is moved by the lower transport member 440 toward the side on which the first end portion 141 (see FIG. 2) of the developing device 14 is located. Then, this developer moves toward the opposite-direction movement path 192 (details of this matter will be described later).

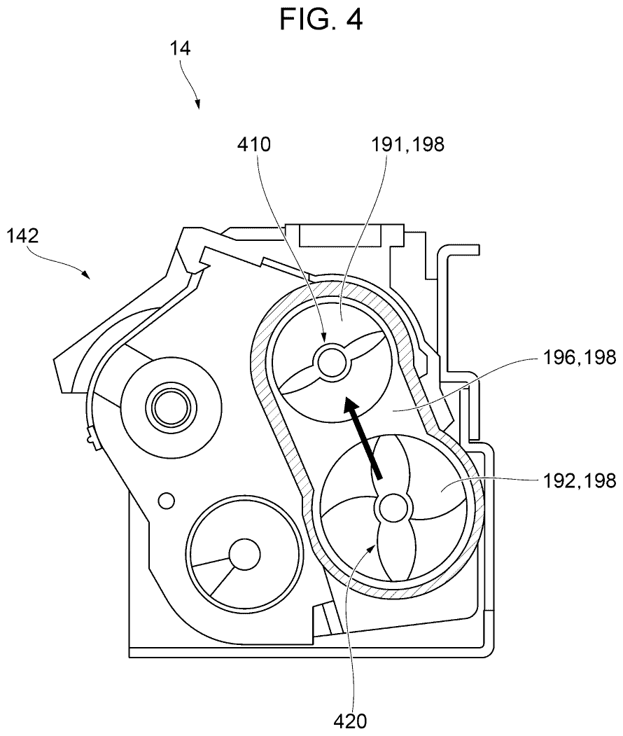

FIG. 4 is a cross-sectional view of the developing device 14 taken along line IV-IV of FIG. 2.

FIG. 4 illustrates a cross section of the developing device 14 at the second end portion 142.

An upward movement path 196 is provided at the second end portion 142 of the developing device 14 so as to extend along the vertical direction. The developer that has moved by passing through the opposite-direction movement path 192 passes through the upward movement path 196 toward the first-direction movement path 191.

In the present exemplary embodiment, the developer accumulates at an end portion of the opposite-direction movement path 192, the end portion being located on the downstream side in a movement direction of the developer. In the present exemplary embodiment, the developer accumulated at this end portion is pressed by the developer that is successively transported from the upstream side. Consequently, the developer accumulated at the end portion moves upward by passing through the upward movement path 196.

As a result, the developer in the opposite-direction movement path 192 passes through the upward movement path 196 toward the first-direction movement path 191.

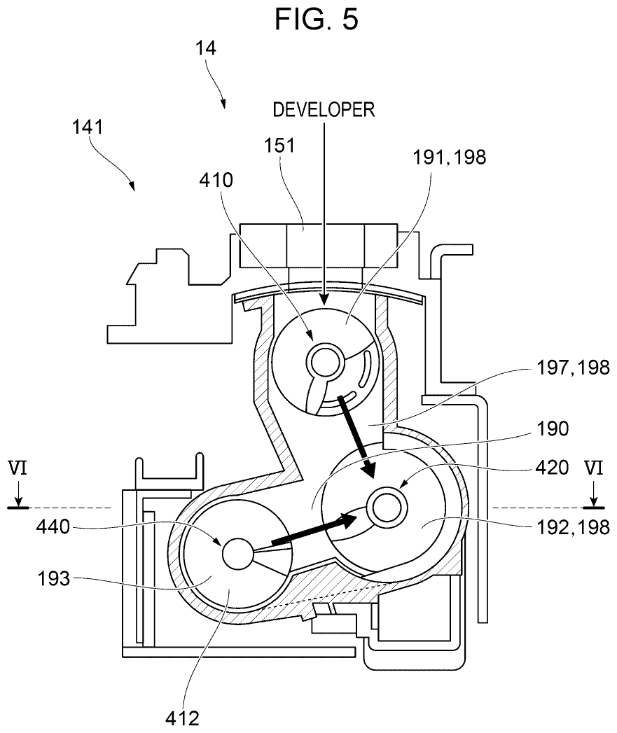

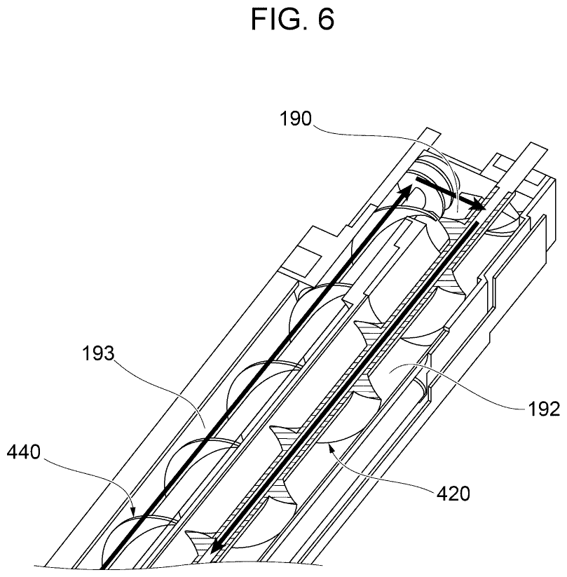

FIG. 5 is a cross-sectional view of the developing device 14 taken along line V-V of FIG. 2. FIG. 6 is a sectional view of the developing device 14 taken along line VI-VI of FIG. 5.

FIG. 5 illustrates a cross section at the first end portion 141 of the developing device 14.

As illustrated in FIG. 5, a downward movement path 197 is provided at the first end portion 141 of the developing device 14 so as to extend along the vertical direction.

The developer that has moved by passing through the first-direction movement path 191 passes through the downward movement path 197 toward the opposite-direction movement path 192.

In the present exemplary embodiment, a connection path 190 is further provided as illustrated in FIG. 5 and FIG. 6. The connection path 190 extends in a lateral direction and connects the lower movement path 193 and the opposite-direction movement path 192 to each other.

In the present exemplary embodiment, the developer is caused by the lower transport member 440 to move along the lower movement path 193. The developer that has moved along the lower movement path 193 then passes through the connection path 190 toward the opposite-direction movement path 192.

In the present exemplary embodiment, the developer accumulates at an end portion of the lower movement path 193, the end portion being located on the downstream side in a movement direction of the developer.

In the present exemplary embodiment, the developer accumulated at this end portion is pressed by the developer that is successively transported from the upstream side. Consequently, the developer accumulated at the end portion moves to the opposite-direction movement path 192 by passing through the opposite-direction movement path 192.

In the present exemplary embodiment, the developer moves along the first-direction movement path 191 (see FIG. 3) and the opposite-direction movement path 192. As a result, in the present exemplary embodiment, the developer moves circularly.

In the present exemplary embodiment, part of the developer that moves along the first-direction movement path 191 is supplied to the rotary body 430. This developer is supplied to the photoconductor drum 11 through the rotary body 430.

The developer that remains on the surface of the rotary body 430 without being supplied to the photoconductor drum 11 is separated from the rotary body 430 and moves toward the lower movement path 193. Then, the developer moves to the opposite-direction movement path 192 via the lower movement path 193.

In the present exemplary embodiment, as illustrated in FIG. 2, the developing device 14 has a first receiving port 151 for receiving the developer. The developing device 14 receives the developer, which is delivered from the supply device 70, through the first receiving port 151.

As illustrated in FIG. 5, the developer delivered from the supply device 70 enters the developing device 14 through the first receiving port 151.

In addition, in the present exemplary embodiment, the developing device 14 has a second receiving port 152 provided at a portion denoted by reference sign 2A in FIG. 2. The second receiving port 152 is closed by a closing member 153.

In the present exemplary embodiment, a user may manually supply a new developer to the developing devices 14 by using a jig (not illustrated).

In the case where the user manually supplies a new developer to the developing device 14, the user removes the closing member 153 first. Then, the user supplies the developer to the developing device 14 through the second receiving port 152 appeared as a result of the removal of the closing member 153.

As illustrated in FIG. 3, the developing device 14 according to the present exemplary embodiment has the opposing opening 480 at which the rotary body 430 is installed.

In the developing device 14 according to the present exemplary embodiment, the first receiving port 151, the second receiving port 152, and the opposing opening 480 are provided as openings.

In the present exemplary embodiment, the developing device 14 has no openings other than the first receiving port 151, the second receiving port 152, and the opposing opening 480.

The developing device 14 according to the present exemplary embodiment is configured to be provided with a connection opening that allows communication between the interior of the developing device 14 and the outside. In the present exemplary embodiment, the developing device 14 does not have such a connection opening in addition to the first receiving port 151, the second receiving port 152, and the opposing opening 480.

In the present exemplary embodiment, an internal pressure of the developing device 14 is released through an opening that is provided in the supply device 70, not through a connection opening provided in the developing device 14. In the present exemplary embodiment, as will be described later, the internal pressure of the developing device 14 may sometimes be released through an opening that is provided in the developer container 80.

In the present exemplary embodiment, the internal pressure of the developing device 14 is also released through an opening that is provided in a transport device, which will be described later. The transport device is a device that transports the developers discharged from the developing device 14.

In the present exemplary embodiment, the developer attached to the surface of the rotary body 430 returns to the inside of the developing device 14 without being transferred onto the photoconductor drum 11. In this case, the air outside the developing device 14 is taken into the inside of the developing device 14. Consequently, the internal pressure of the developing device 14 increases.

Due to an increase in the internal pressure of the developing device 14, a gas tries to move from the inside of the developing device 14 to the outside. In the present exemplary embodiment, the gas that tries to move from the inside of the developing device 14 to the outside flows toward the supply device 70 (see FIG. 1). The gas also flows toward the transport device, which will be described later.

Then, the gas is discharged to the outside of the supply device 70 through the opening (not illustrated in FIG. 1) formed in the supply device 70. The gas is also discharged to the outside of the supply device 70 through the opening formed in the transport device.

An example of the gas is air.

In a case where the gas is discharged only through the connection opening formed in the developing device 14, the gas in a high-pressure state is likely to be discharged.

In contrast, in the present exemplary embodiment, the gas is discharged through the opening formed in the supply device 70, which is located away from the developing device 14. In addition, in the present exemplary embodiment, the gas is discharged through the opening formed in the transport device, which is located away from the developing device 14.

In this case, the gas in a pressure-relieved state is discharged through the opening.

When the gas in a pressure-relieved state is discharged, the amount of the developer that moves toward the outside by passing through the opening is reduced. In this case, a filter that is installed in the opening is less likely to become contaminated, thereby extending the service life of the filter.

Note that providing the connection opening in the developing device 14 is not precluded. A configuration in which the connection opening is provided in the developing device 14 and in which an opening is further provided in the supply device 70 may be employed. Alternatively, a configuration in which the connection opening is provided in the developing device 14 and in which an opening is further provided in the transport device may be employed.

In this case, the gas inside the developing device 14 is discharged to the outside of the developing device 14 through the connection opening.

In addition, in this case, the gas inside the developing device 14 is discharged to the outside of the developing device 14 through the opening formed in the supply device 70. Furthermore, in this case, the gas inside the developing device 14 is discharged to the outside of the developing device 14 through the opening formed in the transport device.

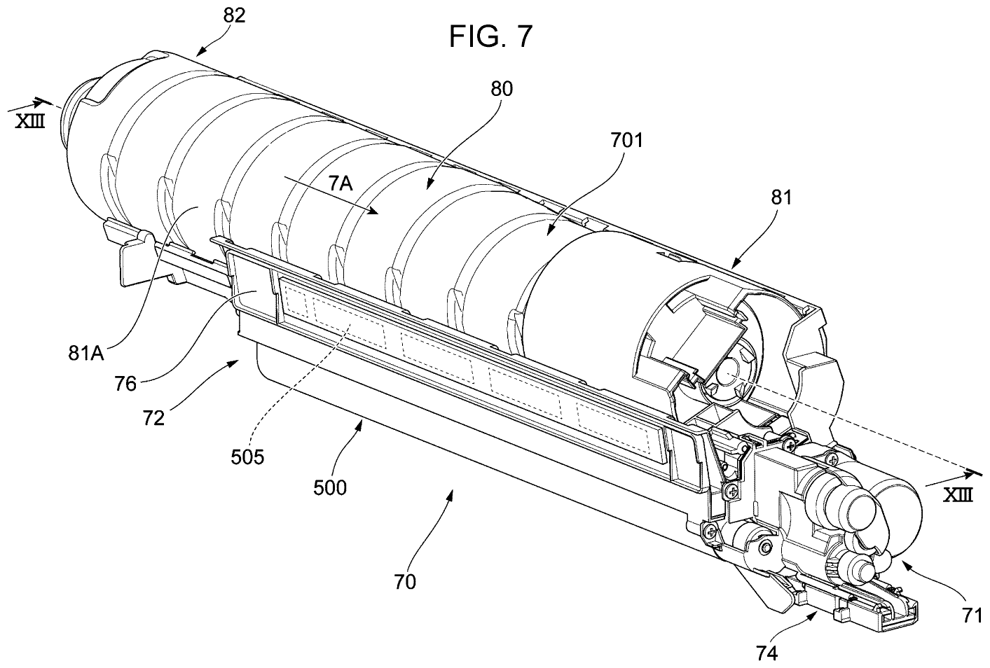

FIG. 7 is a perspective view of one of the supply devices 70 as viewed from the rear side of the image forming apparatus 100. FIG. 7 illustrates the developer container 80 in a mounted state.

For example, an unused developer is stored in the developer container 80. In the present exemplary embodiment, the developer container 80 is attachable to and detachable from the image forming apparatus 100 (see FIG. 1). The developer container 80 is mounted on a mounting portion 701 of the supply device 70.

When the developer container 80 is installed in the image forming apparatus 100, the developer container 80 is moved in the direction of arrow 7A in FIG. 7.

The developer container 80 has a cylindrical shape. More specifically, the developer container 80 has a circular cylindrical shape. Note that the shape of the developer container 80 is not limited to a circular cylindrical shape. The developer container 80 may each have a prismatic shape.

When the developer container 80 is installed in the image forming apparatus 100, the supply device 70 is located below the developer container 80. In the present exemplary embodiment, the developer from the developer container 80 is supplied to the developing device 14 (not illustrated in FIG. 7) by the supply device 70.

The developer container 80 includes a first end portion 81 that is positioned at the front when the developer container 80 is installed in the image forming apparatus 100. The developer container 80 includes a second end portion 82 that is opposite to the first end portion 81.

An outlet for the developer is provided at the first end portion 81 of the developer container 80 and below the developer container 80. The developer in the developer container 80 moves to the supply device 70 located below by passing through the outlet.

The supply device 70 includes a first end portion 71 and a second end portion 72.

The first end portions 71 of the supply devices 70 are located on the rear side of the image forming apparatus 100. The second end portions 72 of the supply devices 70 are located on the front side of the image forming apparatus 100.

The supply device 70 has a receiving port (not illustrated FIG. 7) provided on the side on which the first end portion 71 is located, and the supply device 70 receives the developer from the developer container 80 through the receiving port.

In the present exemplary embodiment, the developer is transported to the supply device 70 from the upstream side of the supply device 70 in a direction in which the developer is transported. The supply device 70 has the receiving port, and the supply device 70 receives the developer that is transported from the upstream side of the supply device 70 through the receiving port.

The developer container 80 has a function of delivering the developer accommodated therein to the outside.

A helical projecting portion is provided in the developer container 80. The developer containers 80 is caused to rotate in its circumferential direction by a driving device, which is not illustrated.

As a result, the helical projecting portion pushes out the developer, which is accommodated in the developer container 80, toward the first end portion 81 of the developer container 80. Consequently, the developer in the developer container 80 moves toward the first end portion 81 of the developer container 80.

Note that, in the developer container 80, a transport member that transports the developer in the developer container 80 toward the first end portion 81 may be provided in addition to the helical projecting portion. In this case, the developer in the developer container 80 is caused to move toward the first end portion 81 by the transport member.

The developer container 80 is positioned further toward the upstream side than their respective supply devices 70 are in the direction in which each developer is transported. The receiving port of the supply device 70 receives the developer supplied from the developer container 80, which is located on the upstream side thereof.

The supply device 70 further includes a developer accumulation unit 500 in which the developer that has entered the inside of the supply device 70 through the receiving port is accumulated.

The developer supplied from the developer container 80 to the supply device 70 is once stored in the developer accumulation unit 500.

The developer is temporarily accumulated in the developer accumulation unit 500.

The developer flows through the inside of the developer accumulation unit 500 and then is discharged from a discharge port 74 that is provided at the first end portion 71 of the supply device 70.

The supply device 70 has the discharge port 74 that is used to discharge the developer received through the receiving port. The developer discharged from the discharge port 74 is supplied to the developing device 14 (not illustrated in FIG. 7) located below the discharge port 74.

In the present exemplary embodiment, the first receiving port 151 (see FIG. 2) of the developing device 14 is positioned directly under the discharge port 74 of the supply device 70.

The developer discharged from the discharge port 74 moves toward the inside of the developing device 14 through the first receiving port 151. As a result, the developer is supplied from the supply device 70 to the developing device 14.

The supply device 70 also has openings 505 that allows communication between the interior of the supply device 70 and the outside.

The developer is once stored in the developer accumulation unit 500.

As a result, even when the developer container 80 is detached, the developer may be supplied from the supply device 70 to the developing device 14.

The developer container 80 is detached as it becomes empty.

In the present exemplary embodiment, even when the developer container 80 is detached, the developer inside the developer accumulation unit 500 is supplied to the developing device 14.

Consequently, even when the developer container 80 is detached, the developer may be supplied from the supply device 70 to the developing device 14.

In this case, even when the developer container 80 is detached, an image forming operation will not immediately stop. In this case, the image formation may be continuously performed until a new developer container 80 is installed.

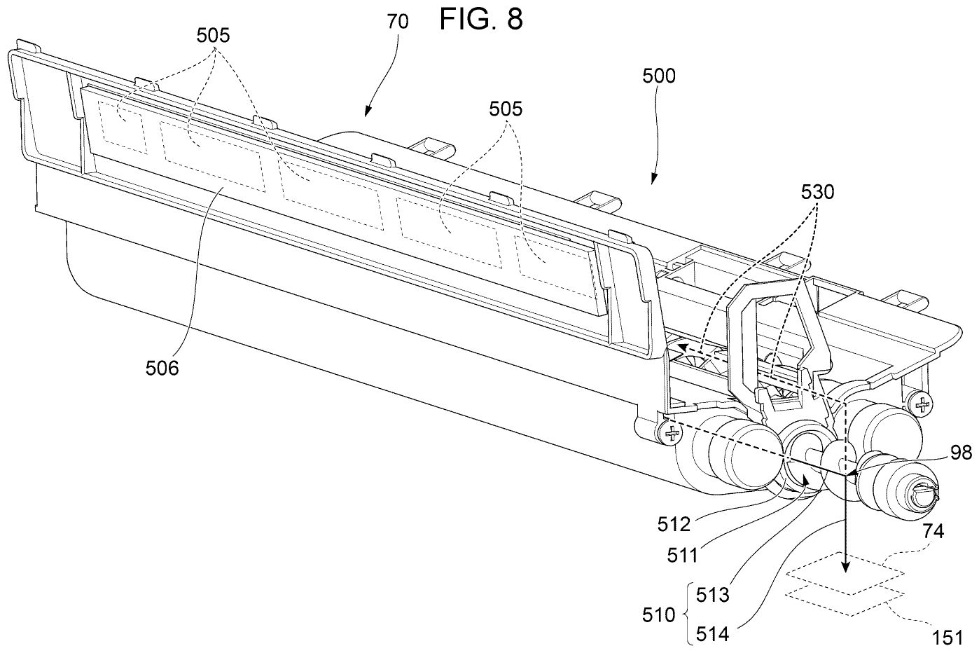

FIG. 8 is a diagram illustrating one of the developer accumulation units 500.

The developer accumulation unit 500 has a developer flow path 510 through which the developer flows toward the developing device 14. The developer flow path 510 is provided in such a manner as to extend from the inside of the developer accumulation unit 500 toward the outside.

A filling portion 511 is present on the developer flow path 510. In the filling portion 511, the cross section of the developer flow path 510 is entirely filled with the developer.

In the present specification, the “cross section” of the developer flow path 510 refers to a cross section of the developer flow path 510 in a plane perpendicular to a direction in which the developer flow path 510 extends.

A cylindrical portion 512 is provided in such a manner as to enclose the filling portion 511. In the present exemplary embodiment, the interior of the cylindrical portion 512 corresponds to the filling portion 511.

In a cross section perpendicular to an axial direction of the cylindrical portion 512, the interior of the cylindrical portion 512 is entirely filled with the developer.

Consequently, in the cross section perpendicular to the axial direction of the cylindrical portion 512, the developer is in a dense state.

As a result, in the present exemplary embodiment, the filling portion 511 to be filled with the developer is formed inside the cylindrical portion 512.

In the configuration in which the filling portion 511 is formed, the amount of the developer that is supplied per unit time from the supply device 70 to the developing device 14 is stabilized.

In the absence of the filling portion 511, density variations are more likely to occur in the developer moving toward the developing device 14. In this case, the amount of the developer supplied per unit time from the supply device 70 to the developing device 14 is likely to fluctuate.

In the direction in which the developer is transported, the developer flow path 510 changes its orientation and extends downward on the downstream side of the filling portion 511.

The developer flow path 510 includes a lateral flow path 513 extending laterally and a vertical flow path 514 extending vertically.

The developer that has flowed through the filling portion 511 flows through the lateral flow path 513 in a direction away from the filling portion 511. After that, the developer flows through the vertical flow path 514 and so as to move downward. The developer falls in the vertical flow path 514.

The discharge port 74 of the supply device 70 and the first receiving port 151 of the developing device 14 are positioned below the vertical flow path 514. The developer that flows through the vertical flow path 514 and moves downward is supplied to the developing device 14.

There is further provided a gas flow path 530 that is a flow path through which a gas that has flowed from the developing device 14 to the supply device 70 flows. The gas flow path 530 is provided separately from the developer flow path 510.

In the present exemplary embodiment, as described above, the gas flows from the developing device 14 toward the supply device 70 as the internal pressure of the developing device 14 increases.

The gas that has flowed from the developing device 14 to the supply device 70 enters the supply device 70 through the discharge port 74 of the supply device 70.

After that, the gas flows upward through the vertical flow path 514, which is an example of a falling portion. Next, the gas enters the gas flow path 530 that is provided so as to branch from the developer flow path 510.

The gas that has entered the gas flow path 530 flows toward the openings 505, which are provided in the supply device 70, and is discharged through the openings 505. A filter 506 is disposed at the openings 505. In FIG. 8, the openings 505 are located at the rear of the filter 506.

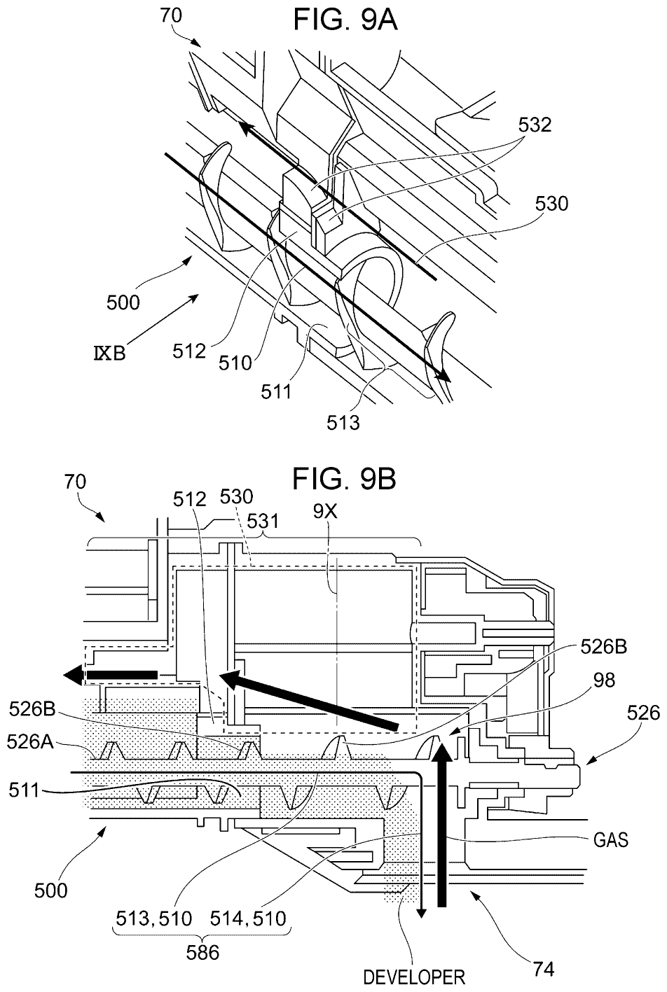

FIGS. 9A and 9B are diagrams each illustrating the filling portion 511 and the gas flow path 530.

FIG. 9A is a perspective view illustrating the filling portion 511 and the gas flow path 530. FIG. 9B illustrates the filling portion 511 and the gas flow path 530 when viewed from the direction of arrow IXB in FIG. 9A.

In the present exemplary embodiment, as described above and illustrated in FIG. 9A, the developer flow path 510 is provided. The developer flow path 510 extends from the inside of the developer accumulation unit 500 to the outside.

The filling portion 511 is present on the developer flow path 510 and inside the cylindrical portion 512. The gas flow path 530 is positioned above the cylindrical portion 512 in FIGS. 9A and 9B. The gas flow path 530 is positioned above the filling portion 511.

As illustrated in FIG. 8, the gas flow path 530 is provided so as to branch from the developer flow path 510.

A branching portion 98 that is an example of a branching point where the gas flow path 530 branches from the developer flow path 510 is present. The branching portion 98 is positioned further toward the downstream side than the filling portion 511 is in the direction in which the developer is transported.

The gas flow path 530 branches from the developer flow path 510 at a position further toward the downstream side than the filling portion 511 is in the direction in which the developer is transported.

After branching from the developer flow path 510, the gas flow path 530 extends above the filling portion 511 as illustrated in FIG. 9A.

The gas that flows through the gas flow path 530 flows above the filling portion 511. The gas that flows through the gas flow path 530 flows through a portion other than the filling portion 511 and moves toward the upstream side in the movement direction of the developer.

In the filling portion 511, the developer is in a dense state, making it difficult for gas to flow through the filling portion 511. Accordingly, in the present exemplary embodiment, the gas flow path 530 that allows the gas to flow therethrough is provided at a portion other than the filling portion 511.

As illustrated in FIG. 8, the gas flow path 530 extends from the branching portion 98 toward the side on which the cylindrical portion 512 is disposed. The gas flow path 530 further extends above the cylindrical portion 512 toward the upstream side in the movement direction of the developer.

As will be described later, the gas flow path 530 again communicates with an internal space of the supply device 70. In other words, the gas flow path 530 extends into the internal space of the supply device 70.

The gas flow path 530 again communicates with the internal space of the supply device 70 at a position further toward the upstream side than the filling portion 511 is in the movement direction of the developer.

The gas flow path 530 again communicates with the internal space of the supply device 70 at a portion that differs from the branching portion 98.

In the present exemplary embodiment, the branching portion 98 where the gas flow path 530 branches from the developer flow path 510 is present. The gas flow path 530 again communicates with the internal space of the supply device 70 at a portion that differs from the branching portion 98.

As illustrated in FIG. 9B, the gas from the developing device 14 first flows through the vertical flow path 514, which is provided as a portion of the developer flow path 510. The vertical flow path 514 serves as a portion in which the developer moves while falling.

The gas from the developing device 14 flows through the vertical flow path 514. The gas flows toward the upstream side in the movement direction of the developer through the vertical flow path 514.

The filling portion 511 is provided on the developer flow path 510. As described above, in the filling portion 511, the cross section of the developer flow path 510 is entirely filled with the developer.

The vertical flow path 514 is positioned further toward the downstream side than the filling portion 511 is in the movement direction of the developer.

The gas that has flowed from the developing device 14 to the supply device 70 flows upward through the vertical flow path 514, which is illustrated in FIG. 9B.

After that, the gas once enters the lateral flow path 513 and then enters the gas flow path 530 located above the lateral flow path 513. The gas then moves in the left direction in FIG. 9B through the gas flow path 530.

As illustrated in FIG. 9B, the gas flow path 530 extends in the lateral direction. The gas flow path 530 includes a lateral portion 531 that is a laterally extending portion.

As illustrated in FIG. 9A, a bottom surface of the lateral portion 531 is provided with an inclination 532 inclining with respect to the horizontal direction. The inclination 532 inclines upward toward the upstream side in a direction in which the gas slows through the gas flow path 530.

By providing the inclination 532 at the bottom surface, the developer is less likely to accumulate at the bottom surface. The developer that is placed on a portion of the bottom surface of the gas flow path 530 where the inclination 532 is provided moves in a sliding manner. As a result, the developer moves in the lower-right direction in FIG. 9A.

The lateral flow path 513 is located on the downstream side in the lower-right direction. The developer placed on the bottom surface of the gas flow path 530 moves toward the lateral flow path 513.

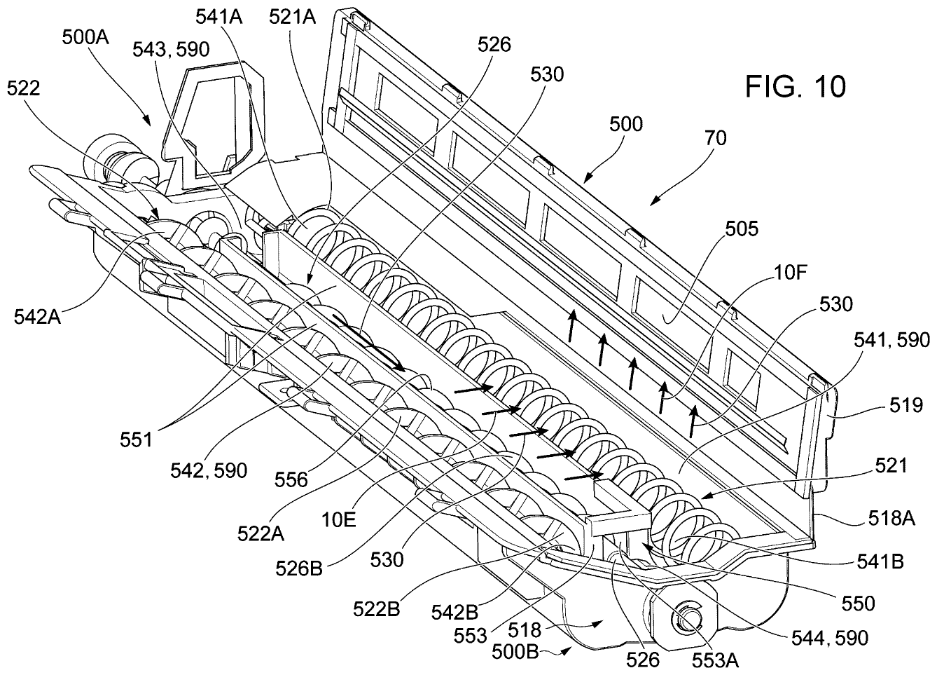

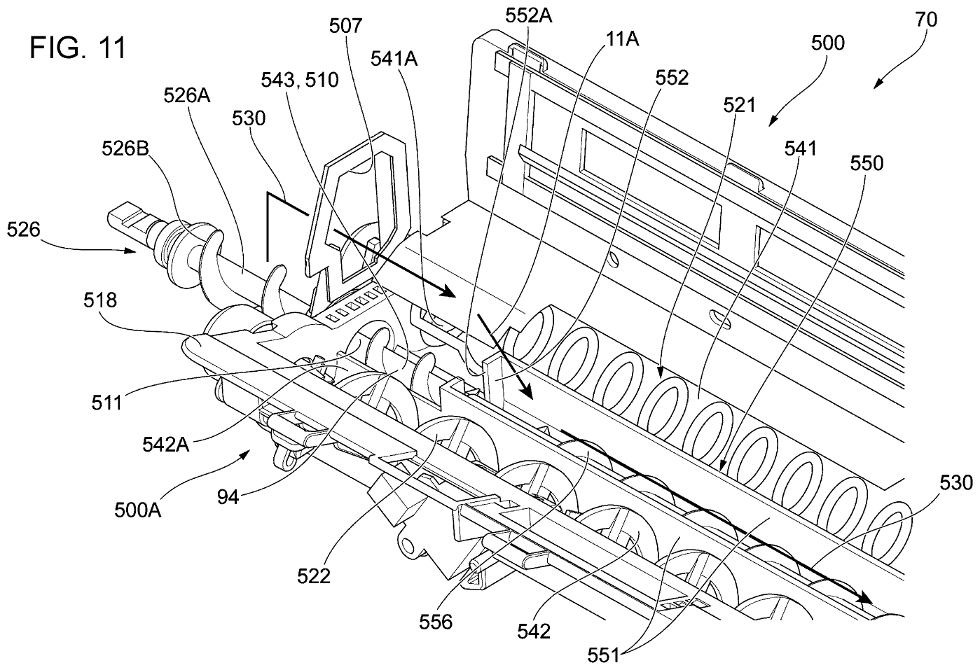

FIG. 10 is a perspective view of one of the developer accumulation units 500 as viewed from above. FIG. 11 is an enlarged view of a first end portion 500A of the developer accumulation unit 500.

FIG. 10 illustrates the developer accumulation unit 500 as viewed from the side on which a second end portion 500B of the developer accumulation unit 500 is located.

As illustrated in FIG. 10, the developer accumulation unit 500 includes a lower container 518 that has a rectangular parallelepiped shape. The developer that is supplied from the developer container 80 (not illustrated in FIG. 10) is first stored in the lower container 518.

A first-direction transport member 521 that transports the developer in the first direction is provided inside the lower container 518. In addition, an opposite-direction transport member 522 that transports the developer in a direction opposite to the first direction is provided inside the lower container 518.

The first-direction transport member 521 and the opposite-direction transport member 522 are arranged parallel to each other. The first-direction transport member 521 and the opposite-direction transport member 522 are each disposed so as to extend in the longitudinal direction of the lower container 518.

A driving source (not illustrated), such as a motor, that drives the first-direction transport member 521 is further provided. In addition, a driving source (not illustrated), such as a motor, that drives the opposite-direction transport member 522 is provided.

The first-direction transport member 521 is formed of a coil. In other words, the first-direction transport member 521 is formed by bending a wire member into a helical shape.

The opposite-direction transport member 522 includes a rod-shaped rotary shaft (not illustrated). This rotary shaft is disposed so as to extend in the longitudinal direction of the lower container 518.

The opposite-direction transport member 522 also includes a projecting portion 522A that projects from the outer peripheral surface of the rotary shaft. The projecting portion 522A is provided around the rotary shaft in a helical manner.

Note that the opposite-direction transport member 522 may be a transport member formed of a coil, similar to the first-direction transport member 521.

The first-direction transport member 521 may be a transport member that includes a rotary shaft and a helical projecting portion, similar to the opposite-direction transport member 522.

Both of the first-direction transport member 521 and the opposite-direction transport member 522 may be a transport member formed of a coil.

Both of the first-direction transport member 521 and the opposite-direction transport member 522 may be a transport member that includes a rotary shaft and a helical projecting portion.

In the present exemplary embodiment, the first-direction transport member 521, which is coil-shaped, rotates about a rotation axis extending along the axial direction of the first-direction transport member 521. As a result, the developer gradually moves in the axial direction of the first-direction transport member 521.

More specifically, the developer moves toward a first end portion 521A of the first-direction transport member 521 in the axial direction of the first-direction transport member 521.

In the present exemplary embodiment, the opposite-direction transport member 522 rotates about the rotary shaft.

As a result, the projecting portion 522A of the opposite-direction transport member 522 pushes out the developer. In response to this, the developer moves in the axial direction of the opposite-direction transport member 522.

More specifically, the developer moves toward a second end portion 522B of the opposite-direction transport member 522 in the axial direction of the opposite-direction transport member 522.

A first-direction flow path 541 is provided inside the lower container 518 and is a flow path through which the developer flows when the developer moves in the first direction.

In addition, an opposite-direction flow path 542 is provided inside the lower container 518 and is a flow path through which the developer flows when the developer moves in the direction opposite to the first direction.

The first-direction flow path 541 and the opposite-direction flow path 542 are arranged parallel to each other. The first-direction flow path 541 and the opposite-direction flow path 542 are each disposed so as to extend in the longitudinal direction of the lower container 518.

The first-direction transport member 521 is disposed in the first-direction flow path 541. The developer that is transported by the first-direction transport member 521 moves inside the first-direction flow path 541.

The opposite-direction transport member 522 is disposed in the opposite-direction flow path 542. The developer that is transported by the opposite-direction transport member 522 moves inside the opposite-direction flow path 542.

In addition, a first-end connection flow path 543 is provided.

The first-end connection flow path 543 is positioned at the first end portion 500A of the developer accumulation unit 500 and inside the lower container 518. The first-end connection flow path 543 connects a first end portion 541A of the first-direction flow path 541 and a first end portion 542A of the opposite-direction flow path 542 to each other.

A second-end connection flow path 544 is also provided.

The second-end connection flow path 544 is positioned at the second end portion 500B of the developer accumulation unit 500 and inside the lower container 518. The second-end connection flow path 544 connects a second end portion 541B of the first-direction flow path 541 and a second end portion 542B of the opposite-direction flow path 542 to each other.

As illustrated in FIG. 10, an annular wall portion 550 that is a wall portion provided in an annular shape is disposed inside the lower container 518.

When the lower container 518 is viewed from above, the annular wall portion 550 has an annular shape. When the lower container 518 is viewed from above, the annular wall portion 550 has a rectangular shape.

The annular wall portion 550 is disposed between the first-direction flow path 541 and the opposite-direction flow path 542. The annular wall portion 550 is disposed between the first-end connection flow path 543 and the second-end connection flow path 544.

As illustrated in FIG. 10, the annular wall portion 550 is disposed in such a manner as to project upward from the bottom surface of the lower container 518. In addition, the annular wall portion 550 is disposed in such a manner as to extend along the longitudinal direction of the lower container 518.

The first-direction flow path 541 and the opposite-direction flow path 542 are arranged around the annular wall portion 550. In addition, the first-end connection flow path 543 and the second-end connection flow path 544 are arranged around the annular wall portion 550.

In the present exemplary embodiment, the developer is transported by the first-direction transport member 521 and the opposite-direction transport member 522. In the internal space of the lower container 518, the developer, which is transported, flows through a space located around the annular wall portion 550.

The developer, which is transported, flows through the first-direction flow path 541 and then reaches the first-end connection flow path 543. After that, the developer moves from the first-end connection flow path 543 to the opposite-direction flow path 542. Next, the developer flows toward the second-end connection flow path 544 through the opposite-direction flow path 542. Then, the developer flows toward the first-direction flow path 541 through the second-end connection flow path 544.

The developer, which is transported, moves along the periphery of the annular wall portion 550 in such a manner as to perform circulating movement. In the present exemplary embodiment, an annular circulation flow path 590 through which the developer performs the circulating movement is provided around the annular wall portion 550.

The circulation flow path 590, which is an example of an annular flow path, includes the first-direction flow path 541, the first-end connection flow path 543, the opposite-direction flow path 542, and the second-end connection flow path 544.

The developer that is transported by the first-direction transport member 521 flows toward the first end portion 541A of the first-direction flow path 541.

The developer then reaches the first end portion 541A. In addition, the developer is transported by the first-direction transport member 521 successively to the first end portion 541A from the upstream side.

The developer that has reached the first end portion 541A is pushed by the developer that is transported from the upstream side. As a result, the developer that has reached the first end portion 541A moves toward the first-end connection flow path 543.

The developer then flows to the opposite-direction flow path 542 through the first-end connection flow path 543.

The developer that has moved to the opposite-direction flow path 542 moves toward the second end portion 542B of the opposite-direction flow path 542.

The developer that has moved to the opposite-direction flow path 542 is moved by the opposite-direction transport member 522 toward the second end portion 542B. As a result, the developer reaches the second end portion 542B.

Then, the developer that has reached the second end portion 542B of the opposite-direction flow path 542 moves toward the second-end connection flow path 544.

In the present exemplary embodiment, the developer is transported by the opposite-direction transport member 522 successively to the second end portion 542B from the upstream side. The developer that has reached the second end portion 542B is pushed by a developer that is successively transported to the second end portion 542B from the upstream side.

As a result, the developer enters the second-end connection flow path 544. After that, the developer reaches the first-direction flow path 541.

Therefore, in the present exemplary embodiment, the developer moves around the annular wall portion 550. In other words, the developer moves along the circulation flow path 590. As a result, in the present exemplary embodiment, the developer performs the circulating movement.

The annular wall portion 550 includes four wall portions.

The annular wall portion 550 includes two axial wall portions 551.

The two axial wall portions 551 extend along the axial direction of the first-direction transport member 521. The two axial wall portions 551 also extend along the axial direction of the opposite-direction transport member 522.

In addition, the two axial wall portions 551 are arranged facing each other. Furthermore, the two axial wall portions 551 are arranged parallel to each other.

As illustrated in FIG. 11, the annular wall portion 550 further includes a first-end wall portion 552. The first-end wall portion 552 is positioned at a first end portion of the annular wall portion 550 in the longitudinal direction of the annular wall portion 550. The first-end wall portion 552 connects the two axial wall portions 551 to each other.

As illustrated in FIG. 10, the annular wall portion 550 further includes a second-end wall portion 553. The second-end wall portion 553 is positioned at a second end portion of the annular wall portion 550 in the longitudinal direction. The second-end wall portion 553 connects the two axial wall portions 551 to each other.

As illustrated in FIG. 11, the first end portion 500A of the developer accumulation unit 500 has an opening 507 through which the gas flow path 530 extends. The gas that flows from the developing device 14 through the gas flow path 530 flows through the opening 507.

As illustrated in FIG. 10, a wall portion 519 that extends upward is further provided.

The wall portion 519 is disposed on a side wall 518A that extends along the longitudinal direction of the lower container 518.

The side wall 518A that extends along the longitudinal direction of the lower container 518 is provided as one of four side walls of the lower container 518. The wall portion 519 is disposed on the side wall 518A that extends in the longitudinal direction of the lower container 518.

The wall portion 519 is disposed in such a manner as to extend along the longitudinal direction of the lower container 518.

The wall portion 519 has the openings 505 that are used to discharge the gas that has flowed from the developing device 14. The openings 505 allow communication between the interior of the supply device 70 and the outside.

The multiple openings 505 are provided. The multiple openings 505 are arranged in the longitudinal direction of the lower container 518.

Each of the openings 505 is formed in such a manner as to extend in the axial direction of the developer container 80, which is mounted on the mounting portion 701 (see FIG. 7).

The gas that has flowed through the gas flow path 530 (see FIG. 11) is eventually discharged through the openings 505 to the outside of the supply device 70.

As illustrated in FIG. 11, a wall-portion inner space 556 that is a space surrounded by the annular wall portion 550 is provided inside the annular wall portion 550.

In the present exemplary embodiment, the gas that has flowed through the gas flow path 530 enters the wall-portion inner space 556 as indicated by arrow 11A.

Then, the gas flows toward the second end portion 500B of the developer accumulation unit 500 (see FIG. 10) through the wall-portion inner space 556.

After that, the gas flows toward the first-direction flow path 541 as indicated by arrows 10E in FIG. 10.

Subsequently, the gas moves along the wall portion 519 as indicated by arrow 10F and flows toward the openings 505, which are formed in the wall portion 519. The gas then moves to the outside of the supply device 70 through the openings 505.

As illustrated in FIG. 11, the above-described filling portion 511 is provided at the first end portion 500A of the developer accumulation unit 500.

A central transport member 526 is further provided so as to extend through the filling portion 511. The central transport member 526 is disposed at a central portion of the lower container 518 in the lateral direction of the lower container 518.

The central transport member 526 is disposed between the first-direction transport member 521 and the opposite-direction transport member 522. The central transport member 526 is also disposed in such a manner as to extend along the longitudinal direction of the lower container 518.

In addition, a driving source (not illustrated), such as a motor, that drives the central transport member 526 is provided.

The central transport member 526 includes a rotary shaft 526A that has a rod-like shape and a projecting portion 526B.

The projecting portion 526B is provided around the rotary shaft 526A in a helical manner. The projecting portion 526B is also provided in such a manner as to project from the outer peripheral surface of the rotary shaft 526A.

In the present exemplary embodiment, the central transport member 526 is caused by the driving source to rotate about the rotary shaft 526A. As a result, the projecting portion 526B pushes out the developer, and the developer moves in the axial direction of the central transport member 526.

In the present exemplary embodiment, the developer in the first-end connection flow path 543 is delivered into the filling portion 511 by the central transport member 526.

The developer that has been transported by the first-direction transport member 521 accumulates at the first-end connection flow path 543.

A space 94 (hereinafter referred to as “pre-filling space 94”) is formed between the filling portion 511 and the first-end wall portion 552.

The first-end connection flow path 543 extends through the pre-filling space 94. The developer that has been transported by the first-direction transport member 521 accumulates in the pre-filling space 94.

In the present exemplary embodiment, the developer that accumulates in the pre-filling space 94 is pushed into the filling portion 511 by the central transport member 526.

As a result, the filling portion 511 is filled with the developer, and then, the developer is supplied to the downstream side.

The developer that has passed through the filling portion 511 flows toward the lateral flow path 513 (see FIG. 9B), which is positioned further toward the downstream side than the filling portion 511 is. After that, the developer flows toward the developing device 14 through the vertical flow path 514.

As illustrated in FIG. 10, the central transport member 526 is disposed so as to extend from a first end portion of the lower container 518 to a second end portion of the lower container 518 in the longitudinal direction of the lower container 518.

The central transport member 526 is also disposed so as to extend through the space surrounded by the annular wall portion 550. In other words, the central transport member 526 is disposed such that a portion thereof is located in the wall-portion inner space 556.

As illustrated in FIG. 11, the first-end wall portion 552 of the annular wall portion 550 has a groove 552A. The central transport member 526 passes through the groove 552A.

In the present exemplary embodiment, by providing the first-end wall portion 552, entry of the developer into the wall-portion inner space 556 may be suppressed. More specifically, the developer in the pre-filling space 94 may be suppressed from entering the wall-portion inner space 556.

As illustrated in FIG. 10, the second-end wall portion 553 of the annular wall portion 550 has an opening 553A. The central transport member 526 is disposed so as to extend through the opening 553A.

In the present exemplary embodiment, by providing the second-end wall portion 553, entry of the developer into the wall-portion inner space 556 may be suppressed. More specifically, the developer in the second-end connection flow path 544 may be suppressed from entering the wall-portion inner space 556.

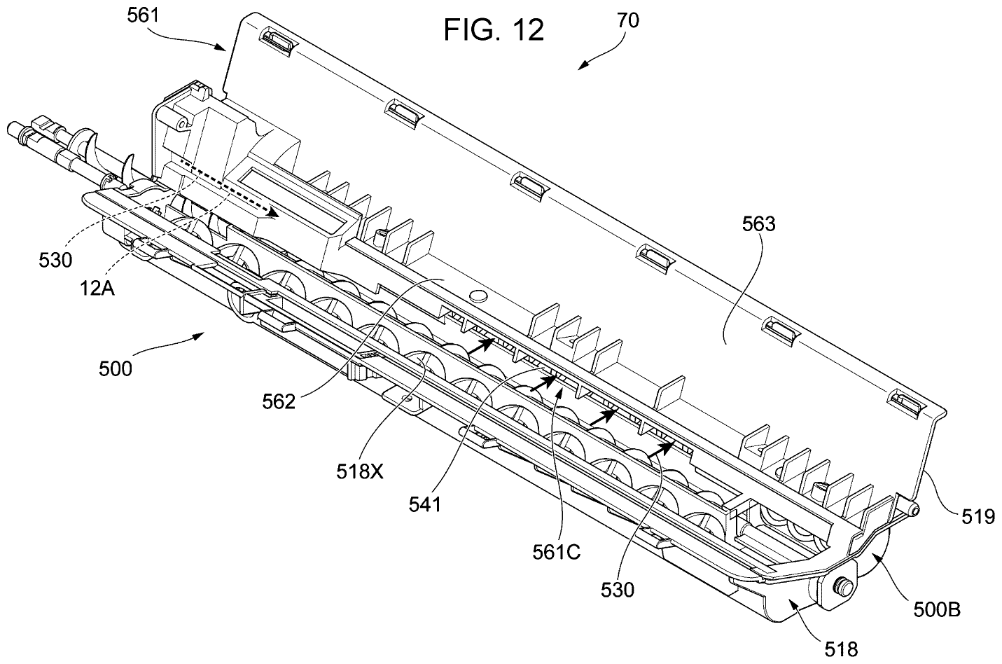

FIG. 12 is a diagram illustrating a state where an upper member 561 is mounted on the lower container 518.

In the supply device 70, the upper member 561 is mounted onto the lower container 518.

The upper member 561 includes a closing portion 562. The closing portion 562 is provided in such a manner as to extend in the horizontal direction. The closing portion 562 closes part of an opening 518X that is located at an upper portion of the lower container 518.

The upper member 561 further includes a wall portion 563.

The wall portion 563 is connected to the closing portion 562. The wall portion 563 is provided in such a manner as to extend upward from the closing portion 562.

The wall portion 563 is disposed so as to face the wall portion 519, which is provided at the lower container 518. A gap that allows the gas to pass therethrough is formed between the wall portion 563 and the wall portion 519.

In other words, a space (described later) that allows the gas to pass therethrough is provided between the wall portion 563 and the wall portion 519.

The gas passes through the opening 507, which is provided at the first end portion 500A of the developer accumulation unit 500 (see FIG. 11).

The gas that has passed through the opening 507 moves as indicated by arrow 12A in FIG. 12.

The gas that has passed through the opening 507 passes through the gap between the lower container 518 and the upper member 561 as indicated by arrow 12A. In addition, the gas flows toward the second end portion 500B of the developer accumulation unit 500.

The gas flow path 530 (see FIG. 11) is provided between the lower container 518 and the upper member 561 (not illustrated in FIG. 11).

The gas that has passed through the opening 507 flows through the gas flow path 530, which is located between the lower container 518 and the upper member 561. Then, as indicated by arrow 12A in FIG. 12, the gas flows toward the second end portion 500B of the developer accumulation unit 500.

After that, the gas enters the wall-portion inner space 556 as indicated by arrow 11A in FIG. 11. The gas then flows toward the second end portion 500B (see FIG. 12) of the developer accumulation unit 500 through the wall-portion inner space 556.

Subsequently, the gas flows toward the first-direction flow path 541 through a recess 561C that is formed on the lower surface of the upper member 561 (see FIG. 12).

The gas then flows above the first-direction flow path 541 and moves toward the space located between the wall portion 563 and the wall portion 519.

Then, the gas flows upward through the space. After that, the gas moves toward the outside of the supply device 70 by passing through the openings 505 (see FIG. 10) formed in the wall portion 519.

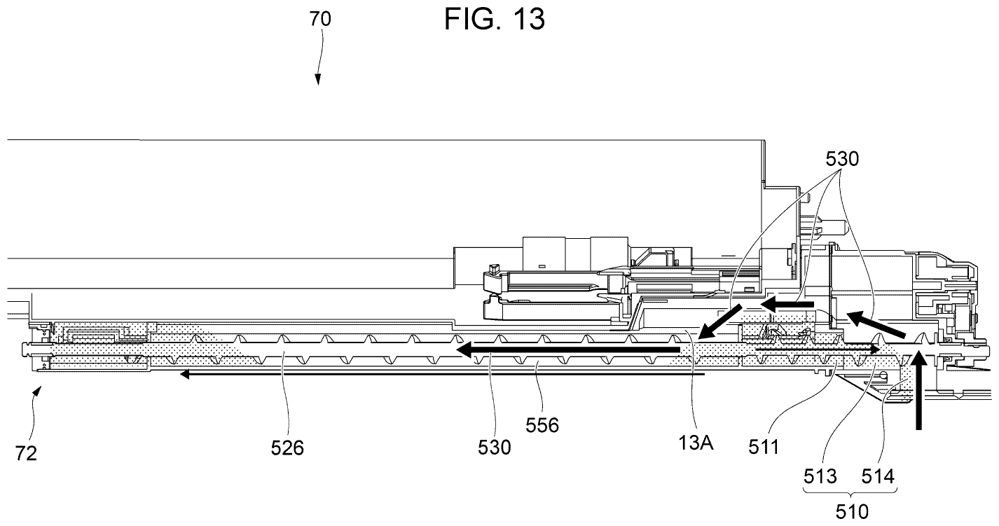

FIG. 13 is a sectional view of the supply device 70 taken along line XIII-XIII of FIG. 7. Note that FIG. 13 does not illustrates the developer container 80, which is illustrated in FIG. 7.

A flow of the gas in the supply device 70 will now be further described with reference to FIG. 13.

In the present exemplary embodiment, the gas from the developing device 14 (not illustrated in FIG. 13) first enters the supply device 70. Then, the gas flows upward through the vertical flow path 514, which is included in the developer flow path 510.

After that, the gas flows toward the second end portion 72 of the supply device 70 through the gas flow path 530, which is provided so as to branch from the developer flow path 510.

The gas flow path 530 again communicates with the internal space of the supply device 70 at a portion denoted by reference sign 13A.

The wall-portion inner space 556, which is located inside the annular wall portion 550 (not illustrated in FIG. 13) is present below the portion denoted by reference sign 13A.

The gas flow path 530 communicates with the wall-portion inner space 556, which is located inside the annular wall portion 550, at the portion denoted by reference sign 13A. The wall-portion inner space 556 is a space that is located inside the supply device 70.

The gas flow path 530 then extends through the wall-portion inner space 556.

The wall-portion inner space 556 is a space that is not located on the developer flow path 510. The wall-portion inner space 556 is a space that is located at a position away from the developer flow path 510.

The gas flow path 530 communicates with the wall-portion inner space 556, which is a space that differs from the developer flow path 510, in the internal space of the supply device 70. The gas flow path 530 extends through the wall-portion inner space 556.

The gas flow path 530 communicates with the wall-portion inner space 556, which is an internal space of the supply device 70.

As indicated by arrow 11A in FIG. 11, the gas flow path 530 communicates with the wall-portion inner space 556 from above the wall-portion inner space 556.

The gas that has entered the wall-portion inner space 556 moves along the longitudinal direction of the wall-portion inner space 556.

The gas flow path 530 extends through the wall-portion inner space 556. The gas flow path 530 is provided in such a manner as to extend in the longitudinal direction of the wall-portion inner space 556. Accordingly, the gas that has entered the wall-portion inner space 556 moves along the longitudinal direction of the wall-portion inner space 556.

The gas flow path 530 extends toward the recess 561C (see FIG. 12) through the wall-portion inner space 556. The gas passing through the gas flow path 530 flows toward the recess 561C.

The gas flow path 530 further extends toward the openings 505 (see FIG. 10) through an upper portion of the first-direction flow path 541. After extending through the upper portion of the first-direction flow path 541, the gas flow path 530 further extends between the wall portion 563 and the wall portion 519 toward the openings 505.

The gas in the wall-portion inner space 556 reaches the upper portion of the first-direction flow path 541 through the recess 561C (see FIG. 12). After that, the gas reaches the openings 505, which are formed in the wall portion 519 (see FIG. 10). Then, the gas moves to the outside of the supply device 70 through the openings 505.

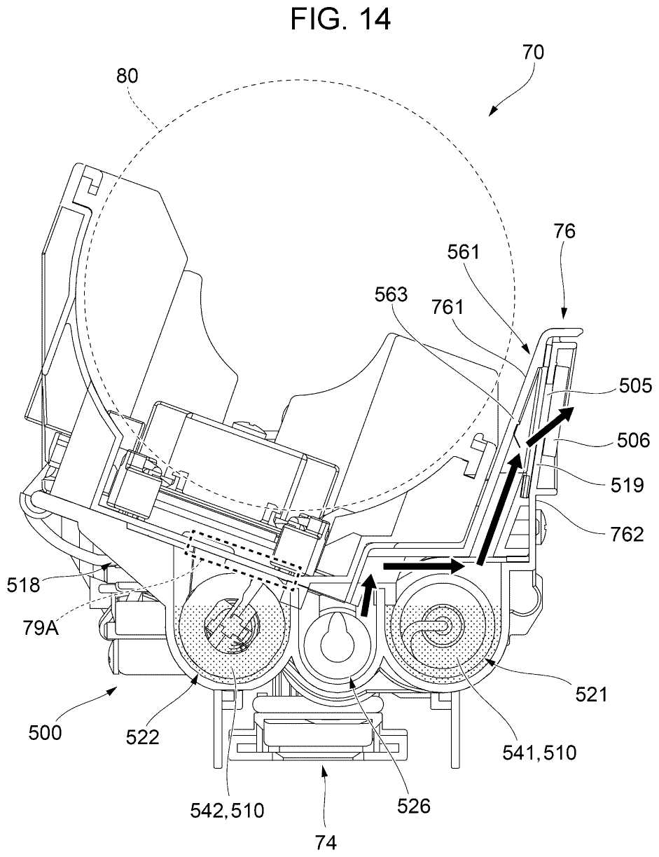

FIG. 14 is a cross-sectional view of one of the supply devices 70 taken in a plane perpendicular to the longitudinal direction of the corresponding developer container 80. In FIG. 14, the developer container 80 is indicated by a dashed line.

The supply device 70 includes a projecting portion 76 extending obliquely upward and having a hollow interior. In the present exemplary embodiment, the openings 505 are formed in the projecting portion 76.

In the present exemplary embodiment, the wall portion 519 is provided at the lower container 518. In addition, the wall portion 563 is provided at the upper member 561.

In the present exemplary embodiment, the wall portion 519 and the wall portion 563 are included in the projecting portion 76. The wall portion 563 and the wall portion 519 project upward. The wall portion 563 and the wall portion 519 are arranged facing each other.

In the present exemplary embodiment, a portion of the projecting portion 76, which extends upward, is located next to the developer container 80.

The projecting portion 76 has a surface 761 that faces the developer container 80. The projecting portion 76 also has an opposite surface 762 that is opposite to the surface 761.

The openings 505 are formed in the opposite surface 762, which is one of the multiple surfaces of the projecting portion 76. The openings 505 are each formed in such a manner as to be oriented toward a side opposite to the side on which the developer container 80 is installed.

In this case, the gas is more easily discharged from the openings 505 compared with the case where the openings 505 are oriented toward the side on which the developer container 80 is installed.

Note that, as mentioned above, the filter 506 is disposed at a position where the filter 506 faces the openings 505.

The supply device 70 has a receiving port 79A through which the supply device 70 receives the developer from the developer container 80. The supply device 70 also has the discharge port 74, which is used to discharge the developer.

The openings 505 formed in the projecting portion 76 are located above the receiving port 79A. In addition, the openings 505 are located above the discharge port 74, which is located below the receiving port 79A.

The openings 505 are each provided at a position away from the developer flow path 510. The developer flow path 510 is provided in the developer accumulation unit 500. The openings 505 are each provided at a position away from the developer flow path 510 in the developer accumulation unit 500.

Note that the filling portion 511 (not illustrated in FIG. 14) is also included in the developer flow path 510. In addition, a portion that is positioned further toward the downstream side than the filling portion 511 is in the movement direction of the developer is also included in the developer flow path 510.

The openings 505 are each provided at a position away from the developer flow path 510.

The openings 505 formed in the projecting portion 76 are openings that allow communication between the interior of the supply device 70 and the outside.

The supply device 70 has the openings 505 separately from the receiving port 79A and from the discharge port 74. The gas that has flowed from the developing device 14 is discharged to the outside of the supply device 70 through the openings 505.

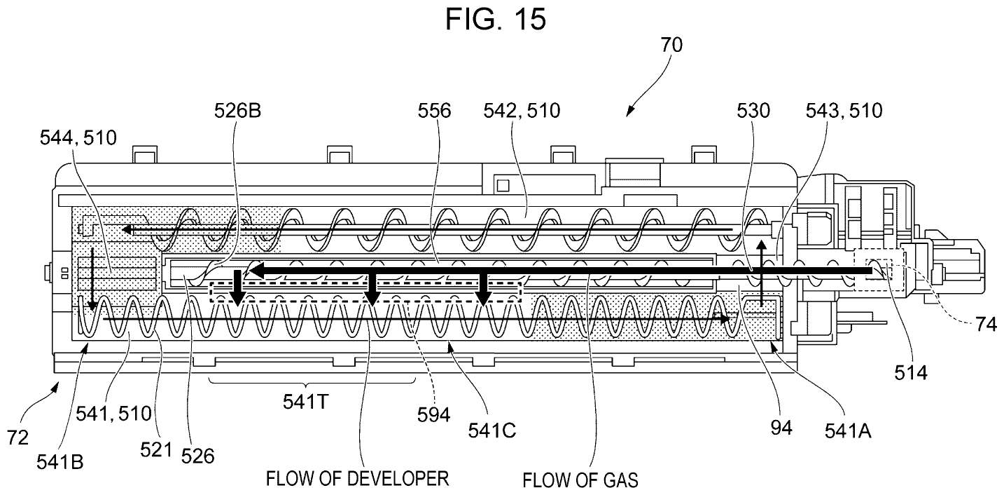

FIG. 15 is a diagram illustrating a flow of the gas when one of the supply devices 70 is viewed from above. In FIG. 15, some members including the upper member 561 are not illustrated.

The gas that has flowed from the developing device 14 enters the supply device 70 through the discharge port 74 of the supply device 70. The gas that has entered the inside of the supply device 70 flows into the gas flow path 530 through the vertical flow path 514.

Subsequently, the gas flows toward the wall-portion inner space 556 through the gas flow path 530. The gas then flows toward the second end portion 72 of the supply device 70 through the wall-portion inner space 556.

The gas flow path 530 extends through the wall-portion inner space 556. Thus, the gas flows toward the second end portion 72 of the supply device 70 by passing through the inside of the wall-portion inner space 556.

Transport of the developer is not performed in the wall-portion inner space 556. Consequently, the amount of the developer in the wall-portion inner space 556 is small.

Then, the gas flows from the wall-portion inner space 556 toward the first-direction flow path 541. More specifically, the gas flows toward a portion of the first-direction flow path 541, the portion differing from the first end portion 541A.

The gas flowing toward the first-direction flow path 541 flows toward a portion of the first-direction flow path 541, the portion being positioned further toward the upstream side than the first end portion 541A is. The term “upstream side” refers to the upstream side in the movement direction of the developer in the first-direction flow path 541.

In the present exemplary embodiment, as illustrated in FIG. 12, the lower surface of the upper member 561 has the recess 561C.

As illustrated in FIG. 15, a connection flow path 594 that is included in the gas flow path 530 is provided at a portion where the recess 561C is formed. The connection flow path 594 is a flow path that allows communication between the wall-portion inner space 556 and the first-direction flow path 541.

As illustrated in FIG. 15, the connection flow path 594 communicates with a central portion 541C of the first-direction flow path 541 in the longitudinal direction of the first-direction flow path 541.

As illustrated in FIG. 15, the connection flow path 594 also communicates with a second-end-side portion 541T of the first-direction flow path 541. The second-end-side portion 541T is a portion that is located closer to the second end portion 541B than the central portion 541C is.

Thus, the gas that has passed through the wall-portion inner space 556 flows toward the central portion 541C as part of its flow to the first-direction flow path 541. In addition, the gas that has passed through the wall-portion inner space 556 also flows toward the second-end-side portion 541T as part of its flow to the first-direction flow path 541.

After that, the gas flows toward the openings 505, which are formed in the projecting portion 76, through the internal space of the projecting portion 76 (see FIG. 14).

The developer that has been transported by the first-direction transport member 521 accumulates at the first end portion 541A of the first-direction flow path 541 (see FIG. 15). As a result, the height of an upper surface of the developer increases at the first end portion 541A.

It may also be conceivable to cause the gas in the wall-portion inner space 556 to flow toward the openings 505 through the first end portion 541A. In this case, however, it may be difficult for the gas to pass above the first end portion 541A.

In contrast, the gas may flow smoothly when it passes above the central portion 541C or above the second-end-side portion 541T. In this case, the gas passes through a portion where the height of the upper surface of the developer is low, and thus, the gas may flow smoothly.

The central transport member 526 is also located in the wall-portion inner space 556.

The central transport member 526, which is an example of a moving member, moves the developer accumulated in the wall-portion inner space 556.

The gas that flows through the gas flow path 530 is supplied to the wall-portion inner space 556. In this case, the developer contained in this gas accumulates in the wall-portion inner space 556.

The developer accumulated in the wall-portion inner space 556 is transported to the pre-filling space 94 by the central transport member 526. The developer in the wall-portion inner space 556 is discharged from the wall-portion inner space 556.

### Another Configuration Example of Supply Device 70

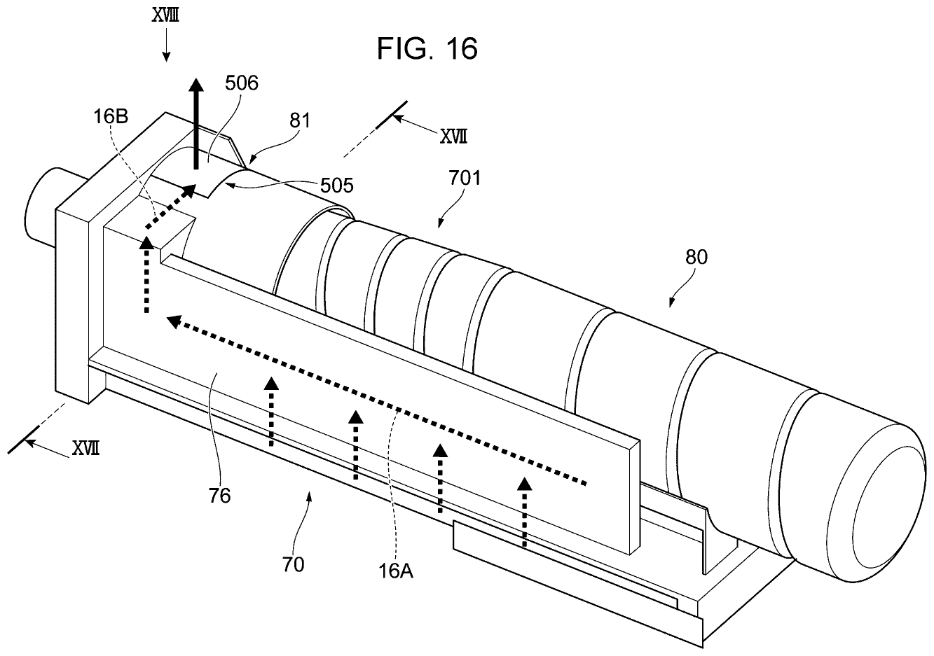

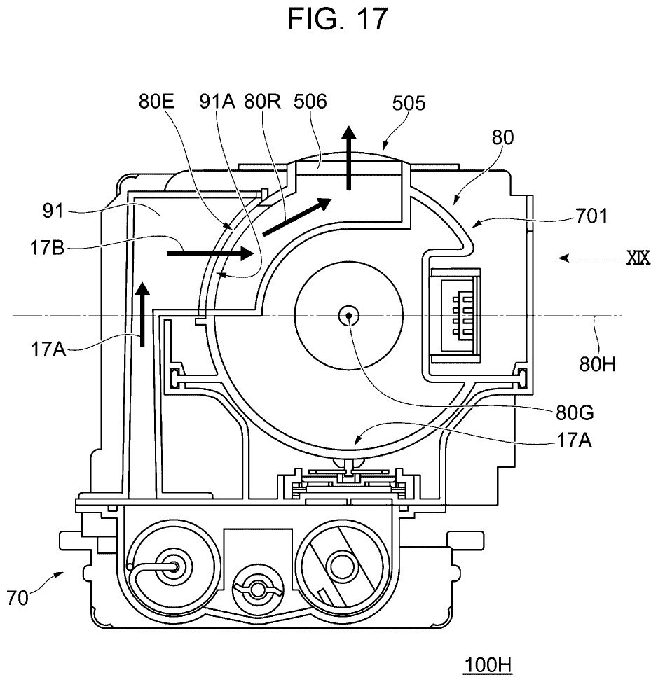

FIG. 16 is a diagram illustrating another configuration example of the supply device 70 and another configuration example of the developer container 80. FIG. 17 is a cross-sectional view of the supply device 70 and the developer container 80 taken along line XVII-XVII of FIG. 16.

In the above description, the projecting portion 76 of the supply device 70 (see FIG. 14) has the openings 505, and the filter 506 is provided at the projecting portion 76.

In contrast, in the configuration example illustrated in FIG. 16, the developer container 80, which is an example of a removable body, has the opening 505. In addition, the filter 506 is provided at this opening 505 of the developer container 80.

As described above, the developer container 80 is a container that stores the developer to be supplied to the developing device 14.

In the state illustrated in FIG. 16, the developer container 80, which is an example of a removable body, is mounted on the mounting portion 701.

Also in this configuration example, the gas discharged from the developing device 14 is supplied to the supply device 70 in a similar manner as described above. The gas supplied to the supply device 70 flows toward a location where the developer container 80 is installed. Subsequently, the gas is supplied to the developer container 80.

The gas supplied from the developing device 14 to the supply device 70 flows toward the mounting portion 701 of the developer container 80. Then, the gas is supplied to the developer container 80 mounted on the mounting portion 701.

Specifically, the gas that has reached the supply device 70 from the developing device 14 first enters the projecting portion 76. More specifically, the gas that has reached the supply device 70 from the developing device 14 enters the projecting portion 76 through the wall-portion inner space 556 (see FIG. 11) and the like.

After that, in the present configuration example, the gas moves along the axial direction of the developer container 80 as indicated by arrow 16A. The gas moves toward the side on which the first end portion 81 is present in the axial direction of the developer container 80.

Note that, in the supply device 70 illustrated in FIG. 16, the position at which the projecting portion 76 is disposed differs form that described above.

In the configuration example illustrated in FIG. 7, when the projecting portion 76 is viewed from the first end portion 81 of the developer container 80, the projecting portion 76 is located further toward the left side than the developer container 80 is.

In contrast, in the configuration example illustrated in FIG. 16, the projecting portion 76 is located further toward the right side than the developer container 80 is. When the projecting portion 76 is viewed from the first end portion 81 of the developer container 80, the projecting portion 76 is located further toward the right side than the developer container 80 is.

The arrangement position of the projecting portion 76 is not particularly limited, and the projecting portion 76 may be located further toward the left side or right side than the developer container 80 is.

As described above and as indicated by arrow 16A, the gas moves toward the first end portion 81 in the axial direction of the developer container 80.

After that, as indicated by arrow 17A and arrow 17B in FIG. 17, the gas is supplied to the developer container 80. The gas supplied to the developer container 80 once enters the developer container 80.

After that, the gas moves toward the outside of the developer container 80 by passing through the opening 505.

When the gas passes through the opening 505, the gas passes through the filter 506 disposed at the opening 505. In this case, the developer, which is an example of powder that is contained in the gas, is removed by the filter 506.

In the present exemplary embodiment, the source of the gas containing the powder is the developing device 14.

Note that the source is not limited to the developing device 14 and may also be another device. In the case where the source is the other device, the gas from the other device flows toward the mounting portion 701 of the developer container 80. Accordingly, also in this case, it becomes possible to remove the powder from the gas that contains the powder and that is generated by the other device.

In the present configuration example, the gas from the developing device 14 is supplied to the developer container 80 via the supply device 70.

However, the present disclosure is not limited to this, and a configuration may be employed in which a dedicated flow path for passing the gas is provided separately from the supply device 70 such that the gas is directly supplied from the developing device 14 to the developer container 80.

Alternatively, the gas from the developing device 14 may be supplied to the developer container 80 via a device other than the supply device 70.

In the configuration example illustrated in FIG. 16 and FIG. 17, the gas flows from the installation position of the developing device 14 toward the developer container 80. In the configuration example illustrated in FIG. 16 and FIG. 17, the gas flows from a location other than the installation portion of the developer container 80 toward the developer container 80.

As described above, the filter 506 is provided at the developer container 80.

The filter 506 removes the developer contained in the gas that has flowed from the developing device 14 to the developer container 80.

Note that the term “remove” refers to reducing the developer contained in the gas. The term “remove” is not limited to a manner in which all of the developer contained in the gas is removed. The term “remove” also includes a manner in which the developer contained in the gas is reduced.

In the present exemplary embodiment, when the developer container 80 mounted on the mounting portion 701 reaches a predetermined state, the developer container 80 is removed. Then, a new developer container 80 is mounted on the mounting portion 701.

When the developer container 80 is removed, the old filter 506 is removed from the image forming apparatus 100. Then, when the new developer container 80 is mounted, a new filter 506 is installed.

Note that the term “predetermined state” refers to, for example, the state in which the developer container 80 is empty.

In the present exemplary embodiment, when the developer container 80 becomes empty, a notification is sent to the user via the UI 45 (see FIG. 1). An example of the notification to the user is a notification providing information indicating that the developer in the developer container 80 has been depleted.

In response to this, the user removes the developer container 80 from the mounting portion 701. After that, the new developer container 80 is mounted on the mounting portion 701 by the user. In this case, not only replacement of the developer container 80 but also replacement of the filter 506 are performed.

Note that the term “predetermined state” also refers to, for example, the state in which a container has become full of the powder.

The filter 506 may be provided at the container in which the amount of the powder gradually increases as the image forming apparatus 100 performs image formation. In this case, when the container has become full of the powder, it is replaced with a new container. At this time, the old filter 506 is replaced with a new filter 506.

An example of the container in which the amount of the powder gradually increases is a waste container, which will be described later.

The filter 506 may be provided at a container in which the amount of the powder is gradually reduced as the image forming apparatus 100 performs image formation. An example of this container is the developer container 80, which has been described above.

Alternatively, the filter 506 may be provided in a container in which the amount of the powder gradually increases as the image forming apparatus 100 performs image formation. An example of this container is the waste container, which will be described later.

As illustrated in FIG. 17, the developer container 80 is formed in a cylindrical shape.

A discharge opening is provided at the outer peripheral surface of the developer container 80 and at a lower portion of the developer container 80. The discharge opening is formed at a location indicated by reference sign 17A in FIG. 17. The discharge opening is provided at the outer peripheral surface of the developer container 80 and at the lower portion of the developer container 80.

The discharge opening is located at a position away from a position immediately below the opening 505 and the filter 506. Thus, the discharge opening is not illustrated in FIG. 17.

The discharge opening is used to discharge the developer that is a material stored in the developer container 80. The developer in the developer container 80 moves toward the supply device 70 through the discharge opening.

The opening 505 and the filter 506 are provided on the side opposite to the side on which the discharge opening is provided with respect to an axial center 80G of the developer container 80.

The opening 505 and the filter 506 are provided on the side opposite to the side on which the discharge opening is provided with respect to an imaginary horizontal plane 80H that passes through the axial center 80G.

In the case of this configuration, the degree of freedom in arrangement of the opening 505, the filter 506, and the discharge opening may be improved.

A case will now be assumed where the opening 505 and the filter 506 are provided on the same side as the discharge opening. In this case, the degree of freedom in arrangement of the opening 505, the filter 506, and the discharge opening is likely to be reduced.

In contrast, when the opening 505 and the filter 506 are provided on the side opposite to the discharge opening, the degree of freedom in the arrangement may be improved.

As illustrated in FIG. 17, the developer container 80 has a gas flow path 80R that is a flow path through which the gas flowing from the developing device 14 passes. The gas flow path 80R has an inlet 80E. The gas flowing from the developing device 14 enters the gas flow path 80R through the inlet 80E.

A body-side flow path 91 is provided on the side on which a body 100H of the image forming apparatus 100 is present, and the body-side flow path 91 is a flow path through which the gas flows toward the developer container 80. The body-side flow path 91 is provided in the supply device 70.

The gas flowing from the developing device 14 flows toward the developer container 80 by passing through the body-side flow path 91. The body-side flow path 91 has a discharge port 91A through which the gas is discharged.

In the present configuration example, when the developer container 80 is mounted on the mounting portion 701, the gas flow path 80R and the body-side flow path 91 communicate with each other.

When the developer container 80 is mounted on the mounting portion 701, the inlet 80E of the gas flow path 80R and the discharge port 91A of the body-side flow path 91 face each other. As a result, the gas flow path 80R and the body-side flow path 91 communicate with each other.

The gas flow path 80R starts from the inlet 80E and reaches the opening 505, which is formed in the outer peripheral surface of the developer container 80. The gas flow path 80R reaches the opening 505 from the inlet 80E via the interior of the developer container 80.

The filter 506 is disposed at the opening 505 as mentioned above.

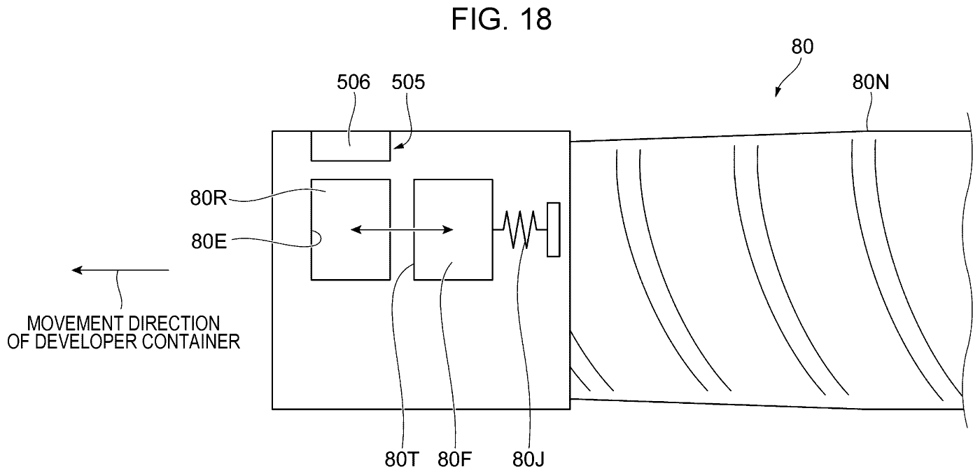

FIG. 18 is a diagram illustrating another configuration example of the developer container 80. FIG. 18 illustrates the developer container 80 as viewed from the direction of arrow XVIII in FIG. 16.

In the present configuration example, a closing portion 80F that closes the inlet 80E of the gas flow path 80R is provided. In addition, an urging member 80J that urges the closing portion 80F is provided.

The urging member 80J urges the closing portion 80F toward the downstream side in a moving direction of the developer container 80.

The term “moving direction” refers to a direction in which the developer container 80 moves when the developer container 80 is mounted on the mounting portion 701.

In a state before the developer container 80 is mounted on the mounting portion 701, the closing portion 80F is located at a position where the closing portion 80F faces the inlet 80E. In this case, the inlet 80E is closed.

When the developer container 80 is mounted on the mounting portion 701, an end portion 80T of the closing portion 80F abuts against an abutting portion (not illustrated) that is a portion to be abutted against. The end portion 80T of the closing portion 80F abuts against the abutting portion that is provided at the body 100H of the image forming apparatus 100 and that is not illustrated.

When the developer container 80 is mounted on the mounting portion 701, the end portion 80T of the closing portion 80F abuts against the abutting portion.

As a result, movement of the closing portion 80F is restricted while a body 80N of the developer container 80 moves.

Therefore, in the present configuration example, when the developer container 80 is mounted on the mounting portion 701, the inlet 80E is opened.

When the developer container 80 is removed, the body 80N of the developer container 80 moves in a direction in which the developer container 80 is removed.

In this case, on the other hand, the closing portion 80F is maintained in a state of abutting against the abutting portion. Thus, the closing portion 80F does not move.

Then, when the body 80N reaches a predetermined position, the closing portion 80F is located at a position where the closing portion 80F faces the inlet 80E. As a result, the inlet 80E is closed by the closing portion 80F.

Providing the closing portion 80F may suppress discharge of the developer from the inlet 80E.

There is a possibility that the developer contained in the gas that has flowed from the developing device 14 may accumulate in the gas flow path 80R. In this case, when the developer container 80 is removed, there is a possibility that the developer accumulated in the gas flow path 80R may be discharged from the inlet 80E.

In addition, in the case of a configuration in which the gas flow path 80R extends through the interior of the developer container 80, there is a possibility that the developer may be discharged from the inlet 80E. More specifically, there is a possibility that the developer in the developer container 80 may be discharged from the inlet 80E.

In contrast, by providing the closing portion 80F as described above, the discharge of the developer from the inlet 80E may be suppressed.

Note that, in the present exemplary embodiment, in a state where the developer container 80 is mounted on the mounting portion 701, the inlet 80E is oriented obliquely upward as illustrated in FIG. 17.

In this case, even if the closing portion 80F is not provided, it is unlikely that discharge of the developer from the inlet 80E will occur. In this case, it is unlikely that discharge of the developer from the inlet 80E will occur while the developer container 80 is being removed.

In addition to orienting the inlet 80E obliquely upward, the closing portion 80F may be provided. In this case, the discharge of the developer from the inlet 80E becomes further less likely to occur.

Alternatively, the inlet 80E may be provided in such a manner as to be oriented in the lateral direction or may be provided in such a manner as to be oriented upward in the vertical direction.

More specifically, the inlet 80E may be provided such that the inlet 80E is oriented in the lateral direction in a state where the developer container 80 is mounted on the mounting portion 701.

Alternatively, the inlet 80E may be provided such that the inlet 80E is oriented upward in the vertical direction in a state where the developer container 80 is mounted on the mounting portion 701.

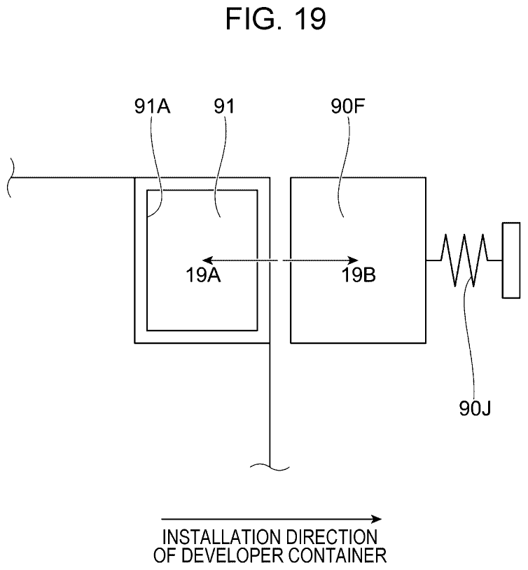

FIG. 19 is a diagram illustrating another configuration example of the body-side flow path 91.

FIG. 19 illustrates the body-side flow path 91 as viewed from the direction of arrow XIX in FIG. 17.

In this configuration example, a closing portion 90F that closes the discharge port 91A, which is provided at the body-side flow path 91, is provided. In addition, an urging member 90J that urges the closing portion 90F in the direction of arrow 19A in FIG. 19 is provided.

The urging member 90J urges the closing portion 90F toward the upstream side in a mounting direction in which the developer container 80 is mounted.

In the present configuration example, a pushing portion (not illustrated) that is provided at the developer container 80 pushes the closing portion 90F. When the developer container 80 is mounted on the mounting portion 701, the pushing portion pushes the closing portion 90F.

As a result, the closing portion 90F moves toward the downstream side in the mounting direction of the developer container 80. The closing portion 90F moves in the direction of arrow 19B in FIG. 19.

When the mounting of the developer container 80 is completed, as illustrated in FIG. 19, the closing portion 90F is located at a position away from a position where it faces the discharge port 91A. As a result, the discharge port 91A is opened.

When the developer container 80 is detached from the image forming apparatus 100, the pushing portion moves in a detachment direction in which the developer container 80 is detached. Along with this, the closing portion 90F also moves in the detachment direction of the developer container 80. The closing portion 90F moves in the direction of arrow 19A in FIG. 19.

When the developer container 80 is removed, the closing portion 90F is located at a position where the closing portion 90F faces the discharge port 91A. As a result, the discharge port 91A is closed by the closing portion 90F.

Providing the closing portion 90F that closes the discharge port 91A may suppress discharge of the developer accumulated in the body-side flow path 91 to the outside of the body-side flow path 91.

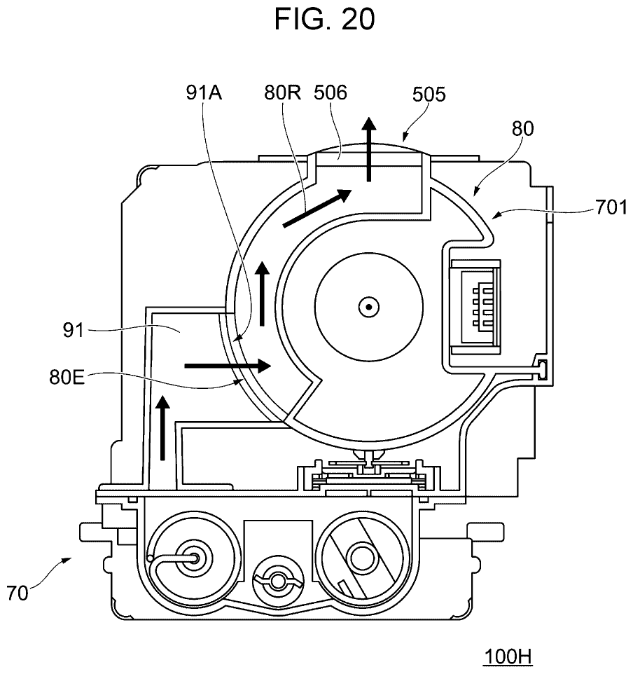

FIG. 20 is a diagram illustrating another configuration example of the supply device 70 and another configuration example of the developer container 80.

In the present configuration example, the discharge port 91A provided at the body-side flow path 91 is oriented obliquely upward.

In this case, the developer accumulated in the body-side flow path 91 is less likely to be discharged to the outside of the body-side flow path 91. In this case, even if the closing portion 90F illustrated in FIG. 19 is not provided, the developer accumulated in the body-side flow path 91 is less likely to be discharged to the outside of the body-side flow path 91.

Note that providing the closing portion 90F is not precluded, and also in the configuration example illustrated in FIG. 20, the closing portion 90F may be provided.

Alternatively, the discharge port 91A of the body-side flow path 91 may be oriented in the lateral direction or may be oriented upward in the vertical direction.

In the configuration example illustrated in FIG. 20, the closing portion 80F that is illustrated in FIG. 18 may be provided. In the configuration example illustrated in FIG. 20, since the inlet 80E is oriented obliquely downward, the closing portion 80F may be provided.

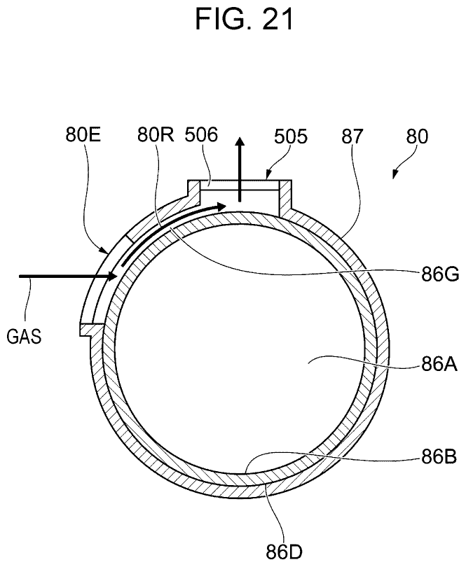

FIG. 21 is a diagram illustrating another configuration example of the developer container 80.

Here, an imaginary plane orthogonal to the axial direction of the developer container 80 is assumed. FIG. 21 illustrates a cross section of the developer container 80 on this imaginary plane.

The developer container 80 includes a storage section 86A that stores the developer, which is the powder stored in the developer container 80. In addition, similar to the above-described configuration, the developer container 80 has the gas flow path 80R.

In the present configuration example, the gas flow path 80R extends toward the filter 506 without passing through the storage section 86A of the developer container 80.

The storage section 86A is provided inside a cylindrical member 86B that is a cylindrical member. In contrast, the gas flow path 80R is provided outside the cylindrical member 86B. The gas flow path 80R does not pass through the storage section 86A of the developer container 80.

Also in the present configuration example, the gas that has flowed from the developing device 14 to the developer container 80 flows through the gas flow path 80R. The gas flows through the gas flow path 80R located outside the cylindrical member 86B.

Then, the gas passes through the gas flow path 80R and reaches the filter 506 that is provided outside the cylindrical member 86B.

In the present configuration example, a space between an outer peripheral surface 86D of the cylindrical member 86B and an opposing member 87 is used as the gas flow path 80R.

In the present configuration example, the developer container 80 includes the cylindrical member 86B as described above. The cylindrical member 86B stores the developer stored in the developer container 80.

In addition, in the present configuration example, the opposing member 87 is provided at a position where the opposing member 87 faces the outer peripheral surface 86D of the cylindrical member 86B.

In the present configuration example, the gap 86G is formed between the outer peripheral surface 86D of the cylindrical member 86B and the opposing member 87. In the present configuration example, the gap 86G is used as the gas flow path 80R.

In the present configuration example, the gas flows through the gas flow path 80R, which is provided outside the cylindrical member 86B, toward the filter 506, which is also provided outside the cylindrical member 86B. The filter 506 is attached to the opposing member 87.

Note that it is not necessary to provide the gas flow path 80R. A configuration in which the developer container 80 does not have the gas flow path 80R may be employed.

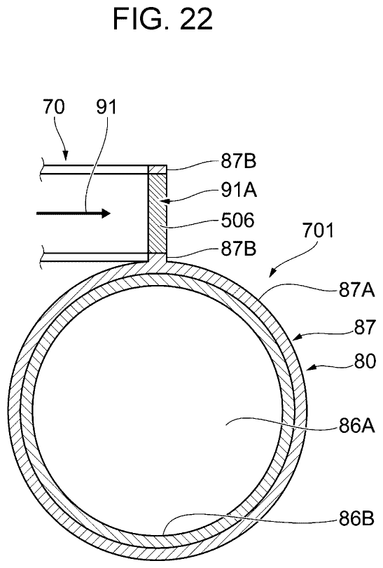

FIG. 22 is a diagram illustrating another configuration example of the supply device 70 and another configuration example of the developer container 80.

In the present configuration example, the filter 506 is disposed outside the outer peripheral surface 87A of the opposing member 87. The filter 506 is disposed in such a manner as to extend along a radial direction of the developer container 80.

The filter 506 is supported by a frame-shaped support member 87B that is positioned around the filter 506.

FIG. 22 illustrates a state where the developer container 80 is mounted on the mounting portion 701. In the present configuration example, the filter 506 is located at a position where the filter 506 faces the discharge port 91A of the body-side flow path 91.

In the present configuration example, when the developer container 80 is mounted on the mounting portion 701, the filter 506 is located at a position where the filter 506 faces the discharge port 91A.

In this case, the gas that is discharged from the discharge port 91A of the body-side flow path 91 is directly supplied to the filter 506.

In this case, the developer container 80 does not necessarily have the gas flow path 80R. In the case where the developer container 80 does not have the gas flow path 80R, it becomes easier to achieve simplification of the configuration of the developer container 80.

In addition, a member for protecting the filter 506 may be provided around the filter 506. In this case, the filter 506 is less likely to become damaged.

### Another Configuration Example of Supply Device

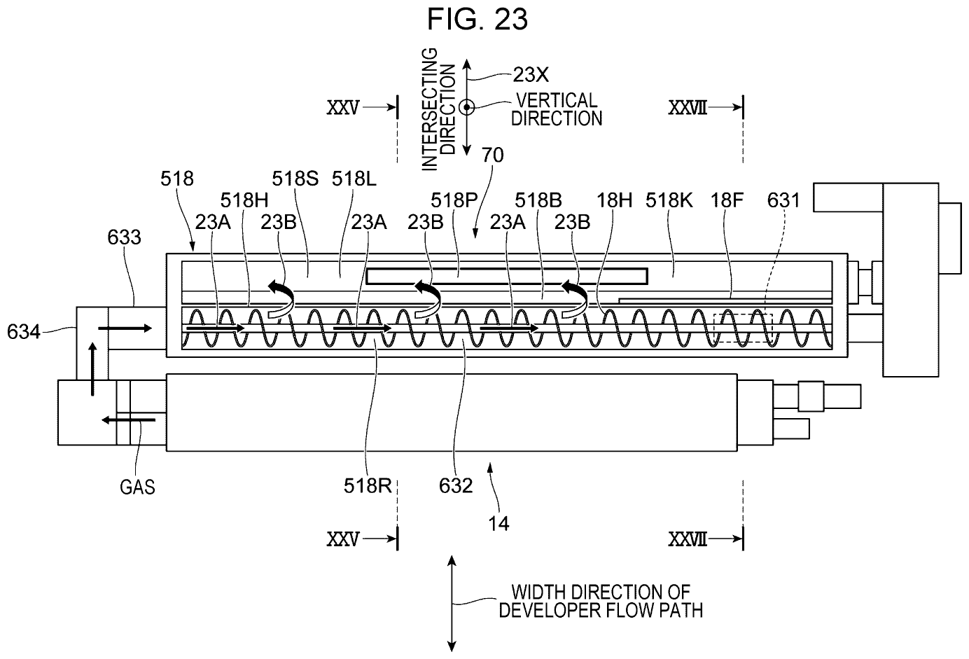

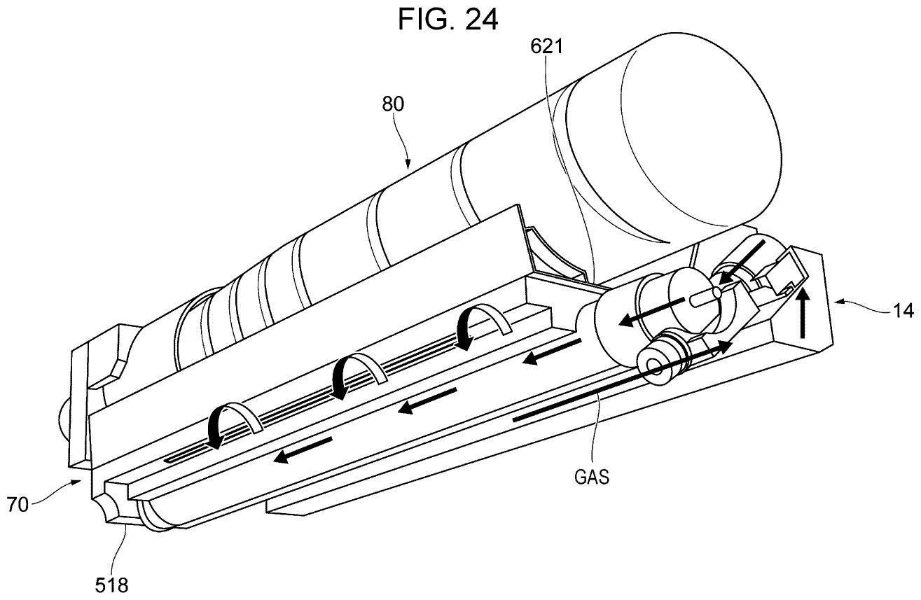

FIG. 23 and FIG. 24 are diagrams each illustrating another configuration example of the supply device 70 and another configuration example of the developing device 14. FIG. 23 is a diagram illustrating the supply device 70 and the developing device 14 as viewed from above. FIG. 24 is a perspective view of the supply device 70 and the developing device 14 as viewed from below.

Similar to the above-described configuration, and as illustrated in FIG. 24, the supply device 70 includes the lower container 518. The developer container 80 is placed on the lower container 518.

A cover member 621 is disposed between the lower container 518 and the developer container 80, which is placed on the lower container 518. The cover member 621 closes an opening 518K that is illustrated in FIG. 23 and that is located at an upper portion of the lower container 518. Note that the cover member 621 and the developer container 80 are not illustrated in FIG. 23.

As illustrated in FIG. 23, a developer flow path 518R is provided inside the lower container 518. The developer that is supplied from the developer container 80 flows through the developer flow path 518R.

The developer flow path 518R is provided in such a manner as to extend in a direction intersecting the vertical direction. More specifically, the developer flow path 518R is provided in such a manner as to extend in the horizontal direction.

The new developer that is supplied from the developer container 80 is supplied to a supply-receiving portion 631. The new developer is supplied to the supply-receiving portion 631 that is a predetermined portion of the developer flow path 518R.

The new developer supplied to the supply-receiving portion 631 moves toward a downstream portion 632 of the developer flow path 518R.

The developer is transported by a transport member 18H and moves toward the downstream portion 632.

The “downstream portion 632” refers to a portion that is positioned further toward the downstream side than the supply-receiving portion 631 is. A movement direction in which the developer moves through the developer flow path 518R will now be assumed. In this movement direction, the downstream portion 632 is positioned further toward the downstream side than the supplied portion 631 is.

The developer enters a cylindrical portion 633 after passing through the downstream portion 632.

Note that, in the present configuration example, the developer does not become dense inside the cylindrical portion 633. The developer is not present in an upper space of the space in the cylindrical portion 633.

The developer that has passed through the cylindrical portion 633 flows toward the developing device 14 through the interior of a tubular member 634 that is disposed so as to intersect the cylindrical portion 633. The tubular member 634 has, for example, a U-shaped cross section.

A transport member that transports the developer is disposed inside the tubular member 634. The developer in the tubular member 634 is caused to flow toward the developing device 14 by the transport member. Then, the developer is supplied to the developing device 14.

A flow of the gas will now be described.

Also in the present configuration example, the gas is discharged from the developing device 14.

The gas discharged from the developing device 14 flows toward the supply device 70 through the tubular member 634. Then, the gas enters the supply device 70 through the cylindrical portion 633 of the supply device 70.

Then, the gas flows along the developer flow path 518R as indicated by arrow 23A. After that, the gas flows toward a side 518S of the developer flow path 518R as indicated by arrow 23B.

In a direction in which the gas flows toward the 518S, a wall portion 518H is provided on the downstream side of the developer flow path 518R. The wall portion 518H is provided so as to extend along the developer flow path 518R.

In addition, a side space 518L is defined on the side 518S of the developer flow path 518R. The side space 518L is a space located on the side 518S of the developer flow path 518R.

The wall portion 518H is disposed between the developer flow path 518R and the side space 518L.

A flow direction of the gas that flows from the developer flow path 518R toward the side 518S of the developer flow path 518R will now be assumed. In this flow direction, the side space 518L is positioned further toward the downstream side than the developer flow path 518R is.

The wall portion 518H has a function of serving as a partition. The wall portion 518H serves to partition the side space 518L and the developer flow path 518R from each other.

In a flow direction of the gas that flows toward the side space 518L, a partition is provided on the downstream side of the developer flow path 518R.

The gas flowing toward the side space 518L moves toward the side space 518L by passing above the wall portion 518H.

The side space 518L includes an opening 518P. The gas that has moved to the side space 518L then reaches the opening 518P.

Subsequently, the gas moves to the outside of the supply device 70 by passing through the opening 518P. In the present configuration example, the opening 518P is provided at a bottom portion of the lower container 518.

Similar to the above-described configuration, the opening 518P in the present configuration example is also used to discharge the gas flowing from the developing device 14 to the supply device 70.

In the present configuration example, the gas that has flowed from the developing device 14 to the supply device 70 flows toward the opening 518P through the developer flow path 518R. Then, the gas moves to the outside of the supply device 70 by passing through the opening 518P.

The opening 518P is formed at a position offset from directly above the developer flow path 518R.

Here, positions in an intersecting direction that is a direction intersecting the vertical direction are compared. In FIG. 23, this intersecting direction is indicated by arrow 23X.

In the configuration example illustrated in FIG. 23, the position of the opening 518P in the intersecting direction and the position of the developer flow path 518R in the intersecting direction differ from each other.

In addition, positions in a width direction of the developer flow path 518R will now be compared. In the configuration example illustrated in FIG. 23, the position of the opening 518P in the width direction and the position of the developer flow path 518R in the width direction differ from each other.

The “width direction” of the developer flow path 518R is a direction perpendicular to a direction in which the developer flow path 518R extends and is the horizontal direction.

In the present configuration example, a recess 518B that is recessed downward is further provided. The recess 518B is located between the opening 518P and the developer flow path 518R in the above-described intersecting direction.

The recess 518B is formed so as to extend along the developer flow path 518R. The recess 518B is extends from a first end to a second end of the developer flow path 518R.

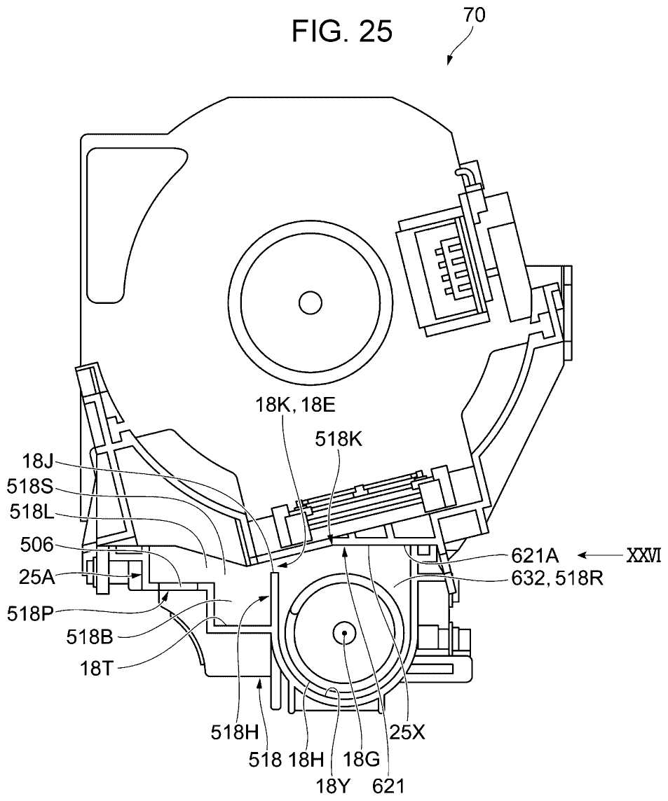

FIG. 25 is a cross-sectional view of the supply device 70 taken along line XXV-XXV of FIG. 23. FIG. 25 illustrates a cross section at the downstream portion 632.

The wall portion 518H projects from the lower side toward the upper side and includes an upper end portion 18J at an end thereof in a projecting direction of the wall portion 518H. The wall portion 518H projects upward from the bottom surface of the lower container 518.

A cover member 621 is disposed above the upper end portion 18J of the wall portion 518H. The cover member 621 closes the opening 518K located at the upper portion of the lower container 518.

The cover member 621 has an opposing surface 621A that is oriented downward and that faces the lower container 518.

A gap 18K is formed between the upper end portion 18J of the wall portion 518H and the opposing surface 621A of the cover member 621.

The gas that flows from the developer flow path 518R toward the side space 518L passes through the gap 18K. The gas moves to the side space 518L through the gap 18K.

A transport member 18H is disposed at the developer flow path 518R. The transport member 18H transports the developer by rotating about a rotation axis 18G that extends along the developer flow path 518R.

The transport member 18H is formed of a coil. In other words, the transport member 18H is formed by bending a wire member into a helical shape.

Here, positions in the vertical direction are compared. In the present configuration example, the upper end portion 18J of the wall portion 518H is located above the rotation axis 18G of the transport member 18H.

In addition, in the present configuration example, the recess 518B is provided on the side opposite to the side on which the developer flow path 518R is formed, with the wall portion 518H interposed therebetween.

The gap 18K between the opposing surface 621A of the cover member 621 and the upper end portion 18J of the wall portion 518H functions as an inlet 18E for the gas.

The gas that has flowed from the developing device 14 flows along the developer flow path 518R. After that, the gas flows toward the side space 518L, which is located on the side 518S of the developer flow path 518R. In this case, the gas passes through the inlet 18E.

The inlet 18E into which the gas flowing from the developer flow path 518R toward the side space 518L flows is provided above the upper end portion 18J of the wall portion 518H. The gas that has flowed along the developer flow path 518R flows toward the side space 518L by passing through the inlet 18E.

The inlet 18E is constituted by the above-mentioned gap 18K. The inlet 18E is formed so as to extend along the direction in which the developer flow path 518R extends.

The gas in the developer flow path 518R enters the side space 518L by passing through the inlet 18E.

After that, the gas passes above the recess 518B and flows toward the opening 518P. Similar to the above-described configuration, the filter 506 is provided at the opening 518P.

The opening 518P is located above a bottom 18T of the recess 518B. In addition, the opening 518P is formed so as to be oriented downward.

The gas that enters the side space 518L contains the developer.

The developer contained in the gas moves to the bottom 18T of the recess 518B on the way to the opening 518P. As a result, the developer accumulates in the recess 518B. Note that, as mentioned above, the recess 518B is formed in such a manner as to extend along the direction in which the developer flow path 518R extends.

In the configuration example illustrated in FIG. 25, the opening 518P is provided at a bottom portion of the lower container 518. However, the present disclosure is not limited to this, and the opening 518P may be provided at a side portion of the lower container 518, such as a portion denoted by reference sign 25A. In any case, the opening 518P may be provided above the bottom 18T of the recess 518B.

Further description will now be given with reference to FIG. 23.

In the present configuration example, a new developer is supplied to the supply-receiving portion 631 of the developer flow path 518R. The developer is supplied from the developer container 80, which is illustrated in FIG. 24, to the supply-receiving portion 631.

The new developer supplied to the supply-receiving portion 631 moves toward the downstream portion 632 of the developer flow path 518R. After that, the developer flows toward the developing device 14 by passing through the cylindrical portion 633.

In the present exemplary embodiment, a closing member 18F is disposed on the side 518S of the developer flow path 518R, that is, on a side of the supply-receiving portion 631. The closing member 18F closes the inlet 18E illustrated in FIG. 25.

The closing member 18F is formed of, for example, a plate-shaped member that is made of a resin. In the present exemplary embodiment, an upper end portion 18X of the closing member 18F comes into contact with the opposing surface 621A of the cover member 621, which is illustrated in FIG. 25.

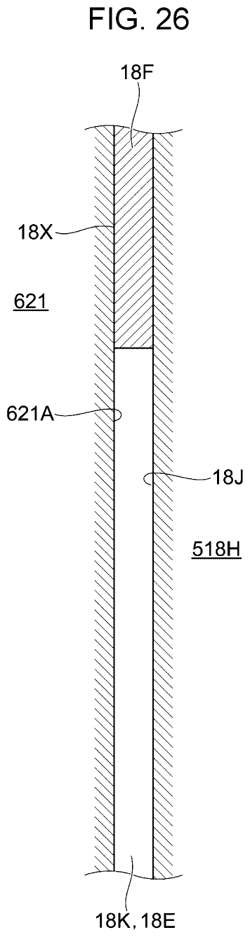

FIG. 26 is a diagram illustrating the inlet 18E as seen from the direction of arrow XXVI in FIG. 25.

In the present exemplary embodiment, a portion of the inlet 18E is closed by the above-mentioned closing member 18F.

More specifically, a portion of the inlet 18E, the portion being located on the side of the supply-receiving portion 631 illustrated in FIG. 23, is closed by the closing member 18F.

Consequently, in the present configuration example, the inlet 18E is not provided on the side of the supply-receiving portion 631.

The closing member 18F illustrated in FIG. 26 is provided on the side of the supply-receiving portion 631. Therefore, in the present configuration example, the inlet 18E is not provided on the side of the supply-receiving portion 631.

In contrast, a portion of the inlet 18E, the portion being located on the side of the downstream portion 632 illustrated in FIG. 23, is not closed. The closing member 18F is not located on the side of the downstream portion 632. Consequently, the portion of the inlet 18E located on the side of the downstream portion 632 illustrated in FIG. 23 is not closed.

The portion of the inlet 18E located on the side of the downstream portion 632 is not closed and is open. The gas from the developing device 14 flows toward the side space 518L through this opened portion of the inlet 18E.

The developer is supplied to the supply-receiving portion 631 from above the supply-receiving portion 631. The developer is supplied to the supply-receiving portion 631 from the developer container 80 that is positioned above the supply-receiving portion 631.

In this case, the developer is likely to float at the supply-receiving portion 631.

If the inlet 18E is not provided on the side of the supply-receiving portion 631 as in the present exemplary embodiment, the floating developer is less likely to move to the side space 518L. In this case, the developer is unlikely to reach the opening 518P in the side space 518L.

In the configuration example illustrated in FIG. 26, the upper end portion 18X of the closing member 18F is in contact with the opposing surface 621A of the cover member 621. Note that the present disclosure is not limited to this configuration, and another configuration may be employed.

For example, a configuration may be employed in which the upper end portion 18X of the closing member 18F and the opposing surface 621A of the cover member 621 are not in contact with each other.

In this case, a gap is formed between the upper end portion 18X and the opposing surface 621A. Even in the case where such a gap is generated, the amount of the developer that flows toward the opening 518P is reduced compared to that in the configuration in which the closing member 18F is not provided.

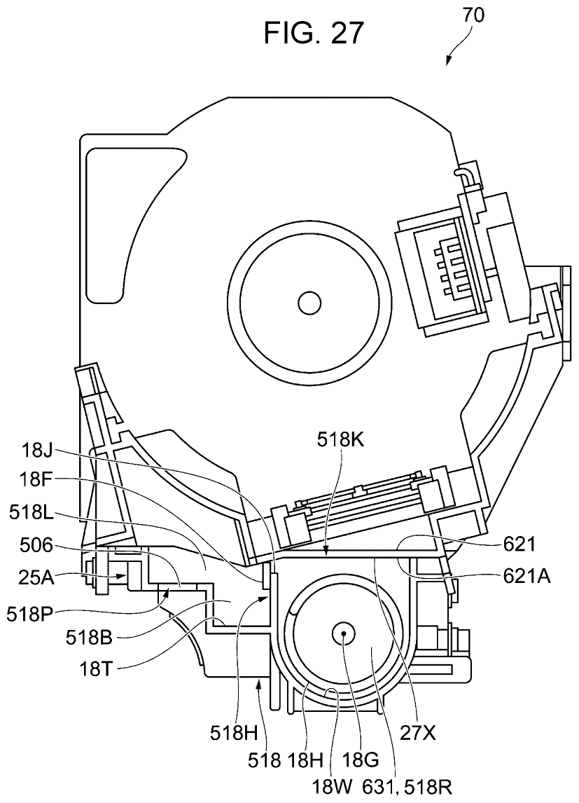

FIG. 27 is a cross-sectional view of the supply device 70 taken along line XXVII-XXVII of FIG. 23. FIG. 27 illustrates a cross section at the supply-receiving portion 631. FIG. 27 illustrates the closing member 18F, which has been described above.

In the present exemplary embodiment, the position of the opposing surface 621A varies as indicated by arrow 25X in FIG. 25 and arrow 27X in FIG. 27. The position of the opposing surface 621A varies in a height direction.

In the present configuration example, the position of the opposing surface 621A in the height direction varies depending on the position in the direction in which the developer flow path 518R extends.

As illustrated in FIG. 25, the position of a portion of the opposing surface 621A, the portion facing the downstream portion 632, in the height direction is the position indicated by reference sign 25X.

As illustrated in FIG. 27, the position of a portion of the opposing surface 621A, the portion facing the supply-receiving portion 631, in the height direction is the position indicated by reference sign 27X.

In the present configuration example, the position indicated by reference sign 27X is located below the position indicated by reference sign 25X.

In the present configuration example, the portion of the opposing surface 621A that faces the supply-receiving portion 631 is located below the portion of the opposing surface 621A that faces the downstream portion 632.

Accordingly, in the present exemplary embodiment, the cross-sectional area of the developer flow path 518R varies depending on the portion of the developer flow path 518R.

The cross-sectional area of the developer flow path 518R, that is, the cross-sectional area at the supply-receiving portion 631, will be referred to as a “cross-sectional area S1”. In addition, the cross-sectional area of the developer flow path 518R, that is, the cross-sectional area at the downstream portion 632, will be referred to as a “cross-sectional area S2”.

In the configuration example illustrated in FIG. 25 and FIG. 27, the cross-sectional area S1 is smaller than the cross-sectional area S2.

In this case, compared with the case where the cross-sectional area S1 is the same as the cross-sectional area S2, floating of the developer at the supply-receiving portion 631 is less likely to occur. In addition, in this case, the amount of the developer that flows toward the side space 518L is reduced.

Alternatively, the cross-sectional area S1 may be made smaller than the cross-sectional area S2 by varying the position of the bottom surface of the developer flow path 518R.

Here, in the bottom surface of the developer flow path 518R, a portion that is positioned below the supply-receiving portion 631 illustrated in FIG. 27 will be referred to as a “supply-receiving bottom surface 18W”. In addition, in the bottom surface of the developer flow path 518R, a portion that is positioned below the downstream portion 632 illustrated in FIG. 25 will be referred to as a “downstream bottom surface 18Y”.

The cross-sectional area S1 may be made smaller than the cross-sectional area S2 by making the position of the supply-receiving bottom surface 18W and the position of the downstream bottom surface 18Y different from each other.

More specifically, the cross-sectional area S1 may be made smaller than the cross-sectional area S2 by positioning the supply-receiving bottom surface 18W above the downstream bottom surface 18Y.

Alternatively, both the position of the opposing surface 621A and the position of the bottom surface of the developer flow path 518R may be varied.

Here, the phrase “the cross-sectional area of the developer flow path 518R” refers to the cross-sectional area of the developer flow path 518R on an imaginary plane orthogonal to the direction in which the developer flow path 518R extends. In other words, the cross-sectional area of the developer flow path 518R refers to the cross-sectional area of the developer flow path 518R on an imaginary plane orthogonal to the movement direction of the developer.

Note that, in the configuration example illustrated in FIG. 23 to FIG. 27, the transport member 18H is a transport member formed of a wire member as mentioned above.

In addition, in the configuration example illustrated in FIG. 23 to FIG. 27, the transport member 18H is configured to be intermittently driven.

Accordingly, in the configuration example illustrated in FIG. 23 to FIG. 27, floating of the developer that is caused by the driving of the transport member 18H is also reduced.

Note that, although not described above, the first-direction transport member 521 and the opposite-direction transport member 522, which are illustrated in FIG. 10, are also intermittently driven.

### Description of Transport Device

The transport device will now be described.

Although not described above, the image forming apparatus 100 of the present exemplary embodiment includes a transport device 800 as illustrated in FIG. 1. The transport device 800 transports the developer discharged from each of the developing devices 14.

In FIG. 1, a portion of the transport device 800 is positioned on the front side relative to the image forming sections 200 and the intermediate transfer belt 15.

In the present exemplary embodiment, a new developer is supplied to the developing devices 14 by the supply devices 70. Accordingly, in the present exemplary embodiment, excess developer is discharged from each of the developing devices 14.

The developer discharged from each of the developing devices 14 is transported to a waste container 850, which will be described later, by the transport device 800.

In the present exemplary embodiment, the gas discharged from each of the developing devices 14 also flows to the transport device 800. The transport device 800 has a gas opening that is an opening used to discharge the gas flowing from the developing device 14 to the transport device 800. The gas opening will be described later.

In the present exemplary embodiment, the gas discharged from the developing devices 14 is flows not only toward the supply devices 70 and the developer containers 80 but also toward the transport device 800.

The gas discharged from one of the developing devices 14 is discharged through the openings 505 of the supply device 70, which are illustrated in FIG. 7. Alternatively, the gas discharged from one of the developing devices 14 is discharged through the opening 505 of the developer container 80, which is illustrated in FIG. 16.

In addition, the gas discharged from the developing device 14 is also discharged through the gas opening, which is an opening of the transport device 800.

Noted that it is not necessary to provide openings in both the supply devices 70 and the transport device 800. An opening may be provided only in each of the supply devices 70 or only in the transport device 800.

In addition, it is not necessary to provide openings in both the transport devices 800 and the transport device 800. An opening may be provided only in each of the developer containers 80 or only in the transport device 800.

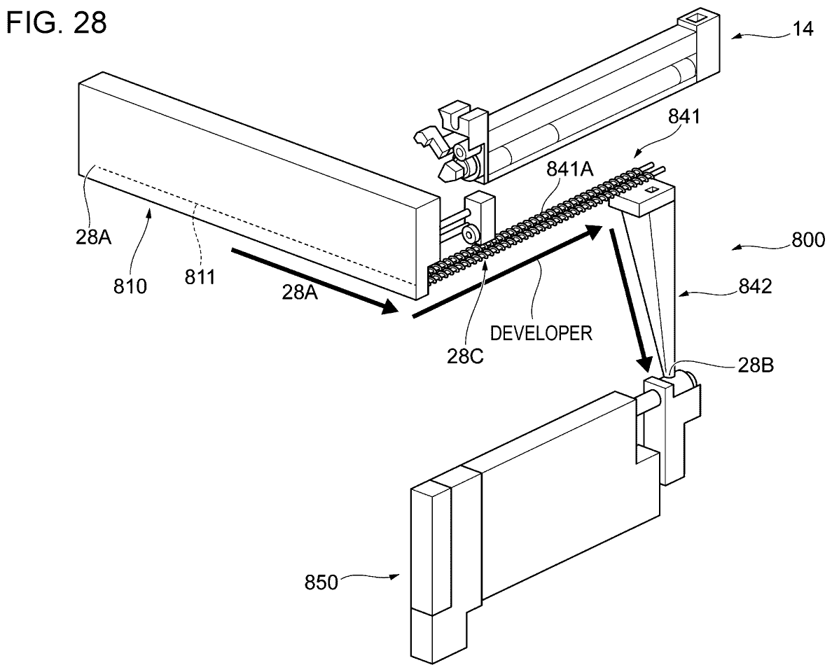

FIG. 28 is a diagram illustrating the transport device 800 and the waste container 850. FIG. 28 illustrates each component as viewed from the front side of the image forming apparatus 100.

In FIG. 28, only one of the multiple developing devices 14 is illustrated. In addition, in FIG. 28, the developing device 14 is illustrated in a state where it has been moved obliquely to the right side in FIG. 28 from its actual installation position.

The transport device 800 transports the developer discharged from each of the developing devices 14 to the waste container 850.

The transport device 800 includes a lateral-direction transport unit 810, a depth-direction transport unit 841, and a vertical-direction transport unit 842.

The lateral-direction transport unit 810 transports the developer discharged from each of the developing devices 14 in the lateral direction as indicated by arrow 28A in FIG. 28. The lateral-direction transport unit 810 transports the developer discharged from each of the multiple developing devices 14 in the lateral direction.

The depth-direction transport unit 841 transports the developer transported by the lateral-direction transport unit 810 toward the rear side of the image forming apparatus 100.

The depth-direction transport unit 841 includes a transport member 841A. The developer is transported toward the rear side of the image forming apparatus 100 by the transport member 841A.

Note that the transport member 841A is accommodated inside a tubular member, which is not illustrated. The developer that is transported by the transport member 841A passes through the interior of the tubular member and flows toward the rear side of the image forming apparatus 100.

The vertical-direction transport unit 842 transports the developer transported by the depth-direction transport unit 841 toward the waste container 850 that is located below the vertical-direction transport unit 842.

The lateral-direction transport unit 810 is detachable. When the developing devices 14 and the like are attached to or detached from the image forming apparatus 100, the lateral-direction transport unit 810 is detached. When the attachment or detachment of the developing devices 14 and the like with respect to the image forming apparatus 100 is completed, the lateral-direction transport unit 810 is attached to the image forming apparatus 100 again.

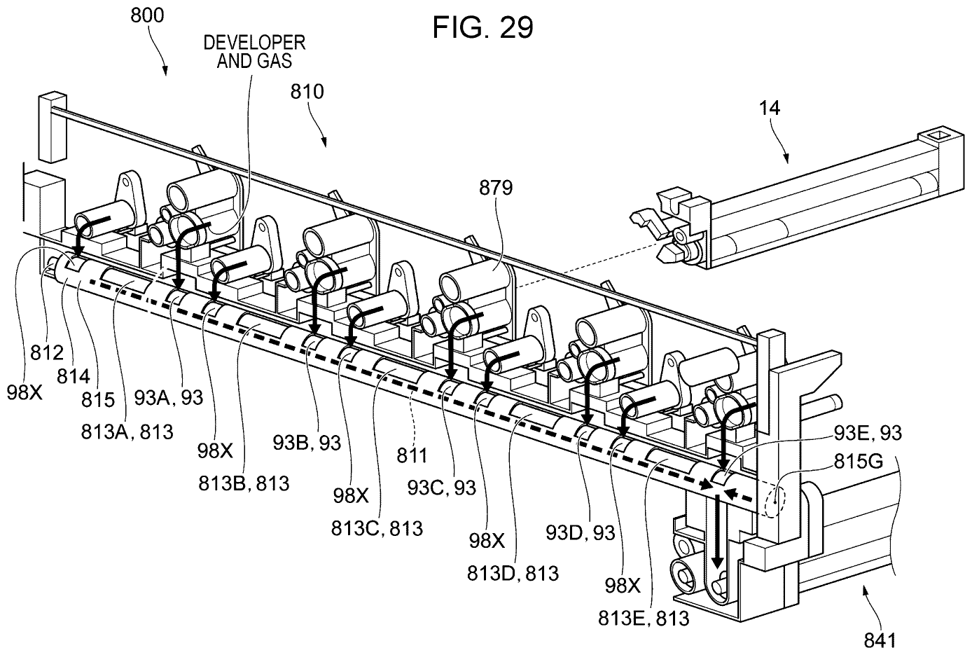

FIG. 29 is a diagram illustrating an internal configuration of the lateral-direction transport unit 810.

The lateral-direction transport unit 810 has a developer flow path 811 through which the developer discharged from each of the developing devices 14 flows. A transport member 812 is provided in the developer flow path 811 and transports the developer in the developer flow path 811 in the direction toward the right side in FIG. 29.

The transport member 812 causes the developer in the lateral-direction transport unit 810 to flow toward the depth-direction transport unit 841.

The developer flow path 811 is provided in such a manner as to extend in the lateral direction. The developer flow path 811 is provided along a direction in which the multiple developing devices 14 are arranged. Note that only one of the developing devices 14 is illustrated in FIG. 29.

In the present exemplary embodiment, the gas discharged from each of the developing devices 14 flows toward gas openings 813 through the developer flow path 811.

A wall portion 814 for forming the developer flow path 811 has inlets 93 through which the gas from the developing devices 14 enters the developer flow path 811.

The gas discharged from each of the developing devices 14 is supplied to the developer flow path 811 of the transport device 800. Then, the gas flows toward the gas openings 813 through the developer flow path 811.

The gas openings 813 are provided at the wall portion 814, which is provided to form the developer flow path 811.

The wall portion 814 is provided around the developer flow path 811 in such a manner as to surround the developer flow path 811. The gas openings 813 are formed in the wall portion 814.

The lateral-direction transport unit 810 includes a tubular member 815 that has a cylindrical shape and in which the developer flow path 811 extends.

The developer discharged from each of the developing devices 14 flows toward the depth-direction transport unit 841 by passing through the interior of the tubular member 815. The gas discharged from each of the developing devices 14 also flows through the interior of the tubular member 815.

The gas openings 813 are provided at the tubular member 815. The gas openings 813 allows communication between the inner space of the tubular member 815 and the outer space.

The tubular member 815 is disposed in such a manner as to extend in a direction intersecting the vertical direction. More specifically, the tubular member 815 is disposed in such a manner as to extend in the horizontal direction.

The gas openings 813 are each provided at a portion of the tubular member 815, the portion being located above an axial center 815G of the tubular member 815.

In other words, each of the gas openings 813 is formed in a portion of the wall portion 814, which is positioned around the developer flow path 811, the portion being located above the axial center 815G.

Note that, although not illustrated in FIG. 29, similar to the above-described configuration, each of the gas openings 813 is provided with the filter 506.

The multiple gas openings 813 are provided.

As the gas openings 813, a first gas opening 813A to a fifth gas opening 813E are provided.

In a movement direction of the developer in the developer flow path 811, the first gas opening 813A is located on the most upstream side. In the movement direction of the developer in the developer flow path 811, the fifth gas opening 813E is located on the most downstream side.

The multiple gas openings 813 are arranged at different positions from each other in a direction in which the developer flow path 811 extends. In addition, as described above, each of the gas openings 813 is provided at the wall portion 814, which is provided to form the developer flow path 811.

In the movement direction of the developer, the gas openings 813 are located upstream of an intermediate position 28C in the direction in which the developer flow path 811 extends.

The developer flow path 811 extends from a portion that is denoted by reference sign 28A in FIG. 28 as a start point to a portion that is denoted by reference sign 28B.

FIG. 28 illustrates the intermediate position 28C in the direction in which the developer flow path 811 extends.

In the present exemplary embodiment, in the movement direction of the developer, the gas openings 813 are positioned further toward the upstream side than the intermediate position 28C is.

More specifically, the fifth gas opening 813E (see FIG. 29) that is located on the most downstream side is located upstream of the intermediate position 28C.

Providing the gas openings 813 upstream of the intermediate position 28C increases the pressure of the gas when the gas reaches the gas openings 813. The pressure of the gas when the gas reaches the gas openings 813 increases compared with the case where the gas openings 813 are located downstream of the intermediate position 28C.

In this case, the gas is more efficiently discharged from the gas openings 813.

The gas openings 813 illustrated in FIG. 29 are formed in the tubular member 815. The multiple gas openings 813 are arranged such that their positions in a direction in which the tubular member 815 extends are shifted from each other.

As described above, the transport device 800 has the developer flow path 811 through which the developer discharged from each of the developing devices 14 flows.

The gas that has flowed from each of the developing devices 14 to the transport device 800 moves by passing through the developer flow path 811. Then, the gas is discharged from the gas openings 813.

As described above, the wall portion 814 for forming the developer flow path 811 has the inlets 93. The gas from the developing devices 14 enters the developer flow path 811 through the inlets 93.

As the inlets 93, a first inlet 93A to a fifth inlet 93E are provided. The inlets 93 are provided such that each of them corresponds to one of the multiple developing devices 14.

The multiple inlets 93 are formed at different positions from each other in the direction in which the developer flow path 811 extends. In other words, the multiple inlets 93 are formed at positions different from each other in the direction in which the tubular member 815 extends.

In the movement direction of the developer in the developer flow path 811, the first inlet 93A is located on the most upstream side. In the movement direction of the developer in the developer flow path 811, the fifth inlet 93E is located on the most downstream side.

Note that, in the present exemplary embodiment, the wall portion 814 for forming the developer flow path 811 is also provided with drum inlets 98X. The multiple drum inlets 98X are provided. The drum inlets 98X are provided at different positions from each other in the direction in which the developer flow path 811 extends.

In the present exemplary embodiment, drum cleaners 17 that are illustrated in FIG. 1 remove the developer from their respective photoconductor drums 11. The removed developer is also supplied to the developer flow path 811 through the drum inlets 98X.

In the present exemplary embodiment, in the movement direction of the developer in the developer flow path 811, each of the gas openings 813 is provided downstream of one of the inlets 93.

More specifically, the second gas opening 813B is provided downstream of the first inlet 93A. The third gas opening 813C is provided downstream of the second inlet 93B. The fourth gas opening 813D is provided downstream of the third inlet 93C. A fifth gas opening 813E is provided downstream of the fourth inlet 93D.

When the gas openings 813 are provided downstream of their respective inlets 93 as in the present exemplary embodiment, backflow of the developer is less likely to occur.

Here, a case is assumed where only one inlet 93 and only one gas opening 813 are provided and where the gas opening 813 is provided upstream of the inlet 93.

In this case, the gas that has entered the developer flow path 811 by passing through the inlet 93 flows toward the upstream side in the movement direction of the developer.

In this case, there is a possibility that the developer may move in a direction opposite to an originally intended transport direction. In other words, there is a possibility that backflow of the developer may occur. There is a possibility that the gas that flows toward the upstream side in the movement direction of the developer may cause backflow of the developer.

In contrast, when the gas opening 813 is provided downstream of the inlet 93 as in the present exemplary embodiment, the backflow is less likely to occur.

Note that each of the inlets 93 is a common inlet 93 that is used for both the developer and the gas.

The developer and the gas are discharged from each of the developing devices 14. The developer and the gas enter the developer flow path 811 by passing through the common inlet 93 provided for each developing device 14.

As illustrated in FIG. 2, in the developing device 14, a discharge path 249 is provided along the extension of the first-direction movement path 191.

In the present exemplary embodiment, the developer in the developing device 14 moves to the outside of the developing device 14 by passing through the discharge path 249. As a result, the developer is discharged from the developing device 14.

In the present exemplary embodiment, part of the developer moving up the upward movement path 196 flows toward the discharge path 249. As a result, part of the developer in the developing device 14 is discharged from the developing device 14.

In the present exemplary embodiment, a discharge transport member 412 is provided separately from the first-direction transport member 410.

Similar to the first-direction transport member 410, the discharge transport member 412 includes the helical projecting portion 479.

In the present exemplary embodiment, a rotational direction of the projecting portion 479 that is included in the first-direction transport member 410 and a rotational direction of the projecting portion 479 that is included in the discharge transport member 412 are opposite to each other.

Consequently, the developer that has entered the discharge path 249 flows toward the side opposite to the side on which the first-direction transport member 410 is disposed. As a result, part of the developer is discharged from the developing device 14.

In the present exemplary embodiment, part of the gas in the developing device 14 moves to the outside of the developing device 14 by passing through the discharge path 249. As a result, the gas is discharged from the developing device 14.

As described above, part of the gas in the developing device 14 flows toward the supply device 70 through the first receiving port 151, which is illustrated in FIG. 2.

Another part of the gas in the developing device 14 flows toward the transport device 800 through the discharge path 249.

Referring to FIG. 29, the transport device 800 will be further described.

In the present configuration example, each of the gas openings 813 is provided between two of the inlets 93 that are adjacent to each other in the direction in which the developer flow path 811 extends.

More specifically, the second gas opening 813B is provided between the first inlet 93A and the second inlet 93B. The third gas opening 813C is provided between the second inlet 93B and the third inlet 93C. The fourth gas opening 813D is provided between the third inlet 93C and the fourth inlet 93D. The fifth gas opening 813E is provided between the fourth inlet 93D and the fifth inlet 93E.

In the present exemplary embodiment, each of the gas openings 813 is provided for each of the multiple sets of two inlets 93. The gas openings 813 each of which is provided between the corresponding two inlets 93 are each provided for each of the multiple sets of two inlets 93.

There are multiple sets of two inlets 93 that are adjacent to each other. Each of the gas openings 813 is provided for each of the multiple sets of two inlets 93 so as to correspond to the two inlets 93.

Note that the phrase “the gas openings 813 each of which is provided between the corresponding two inlets 93” is not limited to an arrangement in which each of the gas openings 813 is located on a straight line connecting the corresponding two inlets 93.

Even in the case where one of the gas openings 813 is located at a position away from the straight line connecting the corresponding two inlets 93, the gas opening 813 corresponds to one of “the gas openings 813 each of which is provided between the corresponding two inlets 93”.

Here, in each of the multiple sets of two inlets 93, the inlet 93 that is positioned further toward the upstream side will be referred to as an upstream inlet 93. The inlet 93 that is positioned further toward the downstream side will be referred to as a downstream inlet 93.

If one of the gas openings 813 and the corresponding two inlets 93 satisfy Condition 1 and Condition 2 below, the gas opening 813 corresponds to one of “the gas openings 813 each of which is provided between the corresponding two inlets 93”.

Condition 1: The gas opening 813 is positioned further toward the downstream side than the upstream inlet 93 is.

Condition 2: The gas opening 813 is positioned further toward the upstream side than the downstream inlet 93 is.

In the present exemplary embodiment, the developer discharged from each of the multiple developing devices 14 moves by passing through the interior of the common tubular member 815, which is a common member. The gas discharged from each of the multiple developing devices 14 also moves by passing through the common tubular member 815.

Here, among the multiple inlets 93, the inlet 93 that is located at an intermediate position is assumed.

In the present exemplary embodiment, at least one of the gas openings 813 is positioned further toward the downstream side in the movement direction of the developer than the inlet 93 that is at the intermediate position is.

The phrase “the inlet 93 that is at the intermediate position” refers to the inlet 93 that is located at the intermediate position in the direction in which the tubular member 815 extends.

Note that, in the case where an even number of the inlets 93 are provided, the phrase “the inlet 93 that is at the intermediate position” refers to the inlet 93 that is positioned further toward the downstream side. In this case, the phrase “the inlet 93 that is at the intermediate position” refers to the inlet 93 that is one of the two inlets 93 each located at an intermediate position, the one being positioned further toward the downstream side than the other is.

In the present exemplary embodiment, the inlet 93 that is located at the intermediate position is the third inlet 93C. In the present exemplary embodiment, the fourth gas opening 813D and the fifth gas opening 813E are provided downstream of the third inlet 93C in the movement direction of the developer.

When the gas openings 813 are provided only upstream of the inlet 93 that is located at the intermediate position, a region where the gas flows backward increases. The region where the gas flows backward increases compared with the case where at least one of the gas openings 813 is provided downstream of the inlet 93 that is located at the intermediate position.

As in the present exemplary embodiment, by providing some of the gas openings 813 downstream of the inlet 93 that is located at the intermediate position, the region where the gas flows backward is reduced. Alternatively, the backflow of the gas does not occur depending on the position of each of the gas openings 813.

In the present exemplary embodiment, some of the gas openings 813 are provided downstream of the inlet 93 that is located at the intermediate position. More specifically, as mentioned above, the fourth gas opening 813D and the fifth gas opening 813E are positioned downstream of the third inlet 93C.

In addition, in the present exemplary embodiment, some of the gas openings 813 are also provided upstream of the third inlet 93C, which is the inlet 93 that is located at the intermediate position.

More specifically, the first gas opening 813A to the third gas opening 813C are positioned upstream of the third inlet 93C. In the present exemplary embodiment, some of the gas openings 813 are also provided upstream of the third inlet 93C.

The gas openings 813 may be provided at portion other than the lateral-direction transport unit 810.

More specifically, for example, the gas openings 813 may be provided at the depth-direction transport unit 841 or the vertical-direction transport unit 842 illustrated in FIG. 28.

Alternatively, the gas openings 813 may be provided at the waste container 850. In this case, the waste container 850 includes the filter 506 that is disposed at a position where the gas openings 813 are provided.

In the case where the gas openings 813 are provided at the waste container 850, as described above, the filter 506 is replaced along with replacement of the waste container 850.

Alternatively, the gas openings 813 may be provided at a member of the transport device 800, the member being configured to be connected to at least one of the developing devices 14.

In the present exemplary embodiment, as illustrated in FIG. 29, connecting members 879 are provided so as to be connected to the developing devices 14. The multiple connecting members 879 are provided such that each of them corresponds to one of the multiple developing devices 14.

The gas openings 813 may be provided at each of the multiple connecting members 879.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming apparatus comprising:
an image carrier;
at least one developing device that applies a developer to the image carrier; and
a transport device that transports a developer discharged from the developing device, the transport device having at least one gas opening that is an opening to be used to discharge a gas that has flowed from the developing device to the transport device.
   (((2)))

The image forming apparatus according to (((1))),
wherein the transport device has a developer flow path through which a developer discharged from the developing device flows, and
wherein a gas that has flowed from the developing device to the transport device flows toward the gas opening by passing through the developer flow path.
   (((3)))

The image forming apparatus according to (((2))),
wherein the gas opening is provided at a wall portion that is provided to form the developer flow path of the transport device, and in a direction in which a developer moves, the gas opening is positioned upstream of an intermediate position in an extending direction in which the developer flow path extends.
   (((4)))

The image forming apparatus according to (((2))) or (((3))),
wherein the gas opening is provided at a wall portion that is provided to form the developer flow path of the transport device,
wherein a wall portion that is provided to form the developer flow path has an inlet through which a gas from the developing device enters the developer flow path, and
wherein, in a direction in which a developer moves in the developer flow path, the gas opening is positioned downstream of the inlet.
   (((5)))

The image forming apparatus according to any one of (((1))) to (((4))),
wherein the at least one gas opening includes a plurality of gas openings,
wherein the transport device has a developer flow path through which a developer discharged from the developing device passes,
wherein a gas that has flowed from the developing device to the transport device moves by passing through the developer flow path, and
wherein the plurality of gas openings are provided at a wall portion that is provided to form the developer flow path and are arranged at different positions from each other in an extending direction in which the developer flow path extends.
   (((6)))

The image forming apparatus according to (((5))),
wherein the at least one developing device includes a plurality of developing devices,
wherein a wall portion that is provided to form the developer flow path has a plurality of inlets through which a gas from the developing device enters the developer flow path, the plurality of inlets being provided such that each of the plurality of inlets corresponds to one of the plurality of developing devices,
wherein the plurality of inlets are arranged at different positions from each other in an extending direction in which the developer flow path extends, and
wherein the gas openings are provided between two inlets that are adjacent to each other in the extending direction, and the gas openings are provided for each of a plurality of sets of the two inlets.
   (((7)))

An image forming apparatus comprising:
an image carrier;
a developing device that applies a developer to the image carrier; and
a supply device that supplies a developer to the developing device and has a developer flow path through which a developer passes and an opening provided at a position offset from directly above the developer flow path, the developer flow path being provided in such a manner as to extend in a direction intersecting a vertical direction, and the opening being used to discharge a gas that has flowed from the developing device to the supply device.
   (((8)))

The image forming apparatus according to (((7))),
wherein a position of the opening in a width direction of the developer flow path differs from a position of the developer flow path in the width direction.
   (((9)))

The image forming apparatus according to (((8))),
wherein a gas that has flowed from the developing device to the supply device flows along the developer flow path and then flows toward a side of the developer flow path, and
wherein, in a direction in which a gas flows toward the side, a wall portion is provided downstream of the developer flow path in such a manner as to extend along the developer flow path.
   (((10)))

The image forming apparatus according to any one of (((7))) to (((9))),
wherein a position of the opening in an intersecting direction that is a direction intersecting a vertical direction and a position of the developer flow path in the intersecting direction differ from each other, and
wherein a recess that is recessed downward is provided between the opening and the developer flow path in the intersecting direction.
   (((11)))

The image forming apparatus according to (((10))),
wherein a position of the opening and a position of the developer flow path differ from each other in the intersecting direction, and a position of the opening and a position of the developer flow path differ from each other also in a width direction of the developer flow path, and
wherein the recess is provided along the developer flow path.
   (((12)))

The image forming apparatus according to any one of (((7))) to (((11)),
wherein a new developer is supplied to a supply-receiving portion that is a predetermined portion of the developer flow path, and a new developer that is supplied to the supply-receiving portion moves toward a downstream portion of the developer flow path, the downstream portion being positioned downstream of the supply-receiving portion in a direction in which a developer moves,
wherein a gas that has flowed from the developing device to the supply device flows toward the opening through the developer flow path, and
wherein a cross-sectional area of the developer flow path, that is, a cross-sectional area at the supply-receiving portion is smaller than a cross-sectional area of the developer flow path, that is, a cross-sectional area at the downstream portion.
   (((13)))

An image forming apparatus that forms an image on a recording medium, the image forming apparatus comprising:
a mounting portion onto which a removable body is mounted and onto which a new removable body is mounted by removing the removable body mounted on the mounting portion when the removable body reaches a predetermined state; and
a filter that is provided at the removable body mounted on the mounting portion, the filter being used to remove powder contained in a gas that has flowed to the removable body from a location other than an installation location of the removable body.
   (((14)))

The image forming apparatus according to (((13))), further comprising:
an image carrier; and
a developing device that applies a developer to the image carrier,
wherein a gas discharged from the developing device flows to an installation position of the removable body, and powder contained in the gas is removed by the filter provided at the removable body.
   (((15)))

The image forming apparatus according to (((14))),
wherein the removable body mounted on the mounting portion is a container that stores a developer to be supplied to the developing device, and
wherein a gas discharged from the developing device flows to an installation position of the container that stores a developer, and powder contained in the gas is removed by the filter provided at the container.
   (((16)))

The image forming apparatus according to any one of (((13))) to (((15))),
wherein the removable body includes a storage section configured to store powder stored in the removable body and has a gas flow path through which a gas that has flowed to the removable body from the position other than the installation position passes, and
wherein the gas flow path extends toward the filter without passing through the storage section of the removable body.
   (((17)))

The image forming apparatus according to (((16))),
wherein the storage section is provided inside a cylindrical member, and
wherein a gas that has flowed to the removable body from the position other than the installation position passes through the gas flow path provided outside the cylindrical member and moves toward the filter provided outside the cylindrical member.
   (((18)))

A removable body configured to be mounted on a mounting portion of an image forming apparatus that forms an image on a recording medium, the removable body comprising:
a filter that is used to remove powder contained in a gas that flows to the mounting portion of the image forming apparatus from a location other than the mounting portion.

What is claimed is:

1. An image forming apparatus comprising:
an image carrier;
at least one developing device that applies a developer to the image carrier; and
a transport device that transports a developer discharged from the developing device, the transport device having at least one gas opening that is an opening to be used to discharge a gas that has flowed from the developing device to the transport device.

2. The image forming apparatus according to claim 1,
wherein the transport device has a developer flow path through which a developer discharged from the developing device flows, and
wherein a gas that has flowed from the developing device to the transport device flows toward the gas opening by passing through the developer flow path.

3. The image forming apparatus according to claim 2,
wherein the gas opening is provided at a wall portion that is provided to form the developer flow path of the transport device, and in a direction in which a developer moves, the gas opening is positioned upstream of an intermediate position in an extending direction in which the developer flow path extends.

4. The image forming apparatus according to claim 2,
wherein the gas opening is provided at a wall portion that is provided to form the developer flow path of the transport device,
wherein a wall portion that is provided to form the developer flow path has an inlet through which a gas from the developing device enters the developer flow path, and
wherein, in a direction in which a developer moves in the developer flow path, the gas opening is positioned downstream of the inlet.

5. The image forming apparatus according to claim 1,
wherein the at least one gas opening includes a plurality of gas openings,
wherein the transport device has a developer flow path through which a developer discharged from the developing device passes,
wherein a gas that has flowed from the developing device to the transport device moves by passing through the developer flow path, and
wherein the plurality of gas openings are provided at a wall portion that is provided to form the developer flow path and are arranged at different positions from each other in an extending direction in which the developer flow path extends.

6. The image forming apparatus according to claim 5,
wherein the at least one developing device includes a plurality of developing devices,
wherein a wall portion that is provided to form the developer flow path has a plurality of inlets through which a gas from the developing device enters the developer flow path, the plurality of inlets being provided such that each of the plurality of inlets corresponds to one of the plurality of developing devices,
wherein the plurality of inlets are arranged at different positions from each other in an extending direction in which the developer flow path extends, and
wherein the gas openings are provided between two inlets that are adjacent to each other in the extending direction, and the gas openings are provided for each of a plurality of sets of the two inlets.

7. An image forming apparatus comprising:
an image carrier;
a developing device that applies a developer to the image carrier; and
a supply device that supplies a developer to the developing device and has a developer flow path through which a developer passes and an opening provided at a position offset from directly above the developer flow path, the developer flow path being provided in such a manner as to extend in a direction intersecting a vertical direction, and the opening being used to discharge a gas that has flowed from the developing device to the supply device.

8. The image forming apparatus according to claim 7,
wherein a position of the opening in a width direction of the developer flow path differs from a position of the developer flow path in the width direction.

9. The image forming apparatus according to claim 8,
wherein a gas that has flowed from the developing device to the supply device flows along the developer flow path and then flows toward a side of the developer flow path, and
wherein, in a direction in which a gas flows toward the side, a wall portion is provided downstream of the developer flow path in such a manner as to extend along the developer flow path.

10. The image forming apparatus according to claim 7,
wherein a position of the opening in an intersecting direction that is a direction intersecting a vertical direction and a position of the developer flow path in the intersecting direction differ from each other, and
wherein a recess that is recessed downward is provided between the opening and the developer flow path in the intersecting direction.

11. The image forming apparatus according to claim 10,
wherein a position of the opening and a position of the developer flow path differ from each other in the intersecting direction, and a position of the opening and a position of the developer flow path differ from each other also in a width direction of the developer flow path, and
wherein the recess is provided along the developer flow path.

12. The image forming apparatus according to claim 7,
wherein a new developer is supplied to a supply-receiving portion that is a predetermined portion of the developer flow path, and a new developer that is supplied to the supply-receiving portion moves toward a downstream portion of the developer flow path, the downstream portion being positioned downstream of the supply-receiving portion in a direction in which a developer moves,
wherein a gas that has flowed from the developing device to the supply device flows toward the opening through the developer flow path, and
wherein a cross-sectional area of the developer flow path, that is, a cross-sectional area at the supply-receiving portion is smaller than a cross-sectional area of the developer flow path, that is, a cross-sectional area at the downstream portion.

13. An image forming apparatus that forms an image on a recording medium, the image forming apparatus comprising:
a mounting portion onto which a removable body is mounted and onto which a new removable body is mounted by removing the removable body mounted on the mounting portion when the removable body reaches a predetermined state; and
a filter that is provided at the removable body mounted on the mounting portion, the filter being used to remove powder contained in a gas that has flowed to the removable body from a location other than an installation location of the removable body.

14. The image forming apparatus according to claim 13, further comprising:
an image carrier; and
a developing device that applies a developer to the image carrier,
wherein a gas discharged from the developing device flows to an installation position of the removable body, and powder contained in the gas is removed by the filter provided at the removable body.

15. The image forming apparatus according to claim 14,
wherein the removable body mounted on the mounting portion is a container that stores a developer to be supplied to the developing device, and
wherein a gas discharged from the developing device flows to an installation position of the container that stores a developer, and powder contained in the gas is removed by the filter provided at the container.

16. The image forming apparatus according to claim 13,
wherein the removable body includes a storage section configured to store powder stored in the removable body and has a gas flow path through which a gas that has flowed to the removable body from the position other than the installation position passes, and
wherein the gas flow path extends toward the filter without passing through the storage section of the removable body.

17. The image forming apparatus according to claim 16,
wherein the storage section is provided inside a cylindrical member, and
wherein a gas that has flowed to the removable body from the position other than the installation position passes through the gas flow path provided outside the cylindrical member and moves toward the filter provided outside the cylindrical member.

18. A removable body configured to be mounted on a mounting portion of an image forming apparatus that forms an image on a recording medium, the removable body comprising:
a filter that is used to remove powder contained in a gas that flows to the mounting portion of the image forming apparatus from a location other than the mounting portion.
